(19) United States
(12) Patent Application Publication
(10) Pub. No.: US 2003/0157260 A1
(43) Pub. Date: Aug. 21, 2003

(54) Polyelectrolyte multilayers that influence cell growth, methods of applying them, and articles coated with them

(76) Inventors: Michael F. Rubner, Westford, MA (US); Jonas D. Mendelsohn, Cambridge, MA (US); Sung Y. Yang, Cambridge, MA (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/278,774

(22) Filed: Oct. 23, 2002

Related U.S. Application Data
(60) Provisional application No. 60/336,269, filed on Oct. 25, 2001.
(60) Provisional application No. 60/402,257, filed on Aug. 9, 2002.

(51) Int. Cl. B05D 1/36

(52) U.S. Cl. 427/402

(57) ABSTRACT

One aspect of the present invention relates to a method of coating a surface, comprising sequentially depositing on a surface, under pH-controlled conditions, alternating layers of polymers to provide a coated surface, wherein a first polymer is selected from the group consisting of pH dependent cationic polyelectrolytes and neutral polymers, and a second polymer is selected from the group consisting of anionic polyelectrolytes, thereby permitting or preventing cell adhesion to said coated surface. In certain embodiments, the aforementioned method provides a coated surface to which cell adhesion is permitted. In certain embodiments, the aforementioned method provides a coated surface to which cell adhesion is prevented. Another aspect of the present invention relates to a method of rendering a surface cytophilic, comprising the step of coating a surface with a polyelectrolyte multilayer film, which film swells to less than or equal to about 150% of its original thickness when exposed to an aqueous medium. Another aspect of the present invention relates to a method of rendering a surface cytophobic, comprising the step of coating a surface with a polyelectrolyte multilayer film, which film swells to greater than or equal to about 200% of its original thickness when exposed to an aqueous medium.

### RELATED APPLICATIONS

This application claims the benefit of priority to U.S. Provisional Patent Application serial No. 60/336,269, filed Oct. 25, 2001; and U.S. Provisional Patent Application serial No. 60/402,257, filed Aug. 9, 2002.

### GOVERNMENT FUNDING

The invention was made with support provided by the National Science Foundation and the MRSEC program of the National Science Foundation; therefore, the government has certain rights in the invention.

### BACKGROUND OF THE INVENTION

The ability to control the interaction of living cells with the surface of synthetic medical implants is a major goal in biomaterials research today, since the performance of any implant depends strongly on the compatibility at the materials-physiological interface. A new paradigm in biomaterials has emerged recently—to eliminate non-specific protein and cell attachment to implants and instead to direct the specific adhesion of certain cells. The ability to engineer the interactions of cells with surfaces is an important albeit demanding task in medicine and biotechnology. Commonly, proteins and cells uncontrollably attach onto medical implant surfaces, which may ultimately lead to undesirable fibrous encapsulation, detrimental clinical complications, an increased risk of infection, and poor device performance. Anderson, J. M. Annu. Rev. Mater. Res. 2001, 31, 81; Ratner, B. D. J. Biomed. Mater. Res. 1993, 27, 837. Consequently, by generating so-called bioinert materials, one may attempt to first reduce any nonspecific physiological responses and then create a truly bioactive system by re-introducing the attachment of only desired cells in a predictable fashion by using specific cell signaling molecules and/or adhesion ligands, often presented in precisely-engineered geometries. Hubbell, J. A. Curr. Opin. Biotechnol. 1999, 10, 123.

Implanted medical devices almost always initiate a foreign body response, consisting of a complex immune and inflammation process in which there is a non-specific adsorption of proteins to the biomaterial surface. Immune and fibroblast cells can adhere via these proteins and often lead to the fibrous encapsulation of the material. Such a foreign body response can lead to clinical complications, hinder device performance, or necessitate implant removal, so by controlling (i.e. usually preventing) the adsorption of proteins to the biomaterial, one can attempt to reduce cell attachment and any negative physiological response. Nevertheless, it is desirable at times to actually have specific cells bind to and/or grow into implants; such applications include: 1) tissue ingrowth into orthopedic implants in order to anchor them and 2) medical devices for tissue engineering, whereby a synthetic polymeric scaffold incorporates living cells in order to guide the regeneration of human tissue. For these situations, cell-binding entities, e.g., proteins and adhesion ligands, may be attached to the material in order to adhere the necessary cells needed to reconstruct the tissue or allow for tissue ingrowth.

To accomplish both of these greater goals—to eliminate non-specific protein and thus undesirable cell adhesion and to direct the attachment and growth of desirable and useful cells—researchers typically use surfaces exhibiting cell-resistant and cell-adherent domains. The cell-resistant region needs to be created from a relatively bio-inert surface, commonly exemplified by oligomeric or polymeric ethylene glycol, also referred to as polyethylene oxide (PEO), a hydrophilic material with a proven ability to resist protein adhesion. In fact, coupling cell-binding proteins to a PEO-rich surface is a popular way in which to prepare hybrid coatings with cell-resistant and cell-adherent domains. Despite its general success in preventing undesirable protein and cell adhesion, PEO is limited in its use; due to its high water solubility, PEO must be grafted to surfaces, yet incomplete surface coverage remains a dilemma. While polymeric or oligomeric ethylene glycol (PEO, PEG, or o-EG) often exemplifies the bioinert background material in such an approach, it unfortunately succumbs to auto-oxidation and hydrolytic degradation over time and thus has poor stability in long-term clinical applications. Wieland, B.; Lancaster, J. P.; Hoaglund, C. S.; Holota, P.; Tornquist, W. J. Langmuir 1996, 12, 2594; Ostuni, E.; Chapman, R. G.; Liang, M. N.; Meluleni, G.; Pier, G.; Ingber, D. E.; Whitesides, G. M. Langmuir 2001, 17, 6336; Luk, Y.-Y.; Kato, M.; Mrksich, M. Langmuir 2000, 16, 9604. Consequently, other materials, including PEG-based hydrogels, dextran, mannitol, or phosphorylcholine, have been explored as viable bioinert alternatives. Tziampazis, E.; Kohn, J.; Moghe, P. V. Biomaterials 2000, 21, 511; Massia, S. P.; Stark, J.; Letbetter, D. S. Biomaterials 2000, 21, 2253; Luk, Y.-Y.; Kato, M.; Mrksich, M. Langmuir 2000, 16, 9604; Tegoulia, V. A.; Rao, W.; Kalambur, A. T.; Rabolt, J. F.; Cooper, S. L. Langmuir 2001, 17, 4396. Typically, self-assembled monolayers (SAMs) or chemical grafting or polymerization methods have been employed to present these resistant materials onto a desired surface. Ostuni, E.; Chapman, R. G.; Liang, M. N.; Meluleni, G.; Pier, G.; Ingber, D. E.; Whitesides, G. M. Langmuir 2001, 17, 6336; Luk, Y.-Y.; Kato, M.; Mrksich, M. Langmuir 2000, 16, 9604; Tegoulia, V. A.; Rao, W.; Kalambur, A. T.; Rabolt, J. F.; Cooper, S. L. Langmuir 2001, 17, 4396; López, G. P.; Albers, M. W.; Schreiber, S. L.; Carroll, R.; Peralta, E.; Whitesides, G. M. J. Am. Chem. Soc. 1993, 115, 5877; Cooper, E.; Parker, L.; Scotchford, C. A.; Downes, S.; Leggett, G. J.; Parker, T. L. J Mater. Chem. 2000, 10, 133; Tidwell, C. D.; Ertel, S. I.; Ratner, B. D.; Tarasevich, B. J.; Arte, S.; Allara, D. L. Langmuir 1997, 13, 3404; Lee, S.-D.; Hsiue, G.-H.; Chang, P. C.-T.; Kao, C.-Y. Biomaterials 1996, 17, 1599; Irvine, D. J.; Mayes, A. M.; Griffith, L. G. Biomacromolecules 2001, 2, 85. However, potential problems with incomplete, non-uniform surface coverage, possible multiple synthetic steps, and the restriction of SAMs to silicon or gold substrates greatly limit these techniques for creating bioinert coatings.

The fabrication of polyelectrolyte multilayer thin films has received much attention recently as a simple yet versatile technique for assembling various thin film optoelectronic devices and nanostructured thin film coatings (for a review, see: Decher, G. Science 1997, 277, 1232). Since the layer-by-layer process creates nanostructured-controlled polyelectrolyte complexes, which have already exhibited a long research history as biomaterials, several groups have begun to realize the potential of multilayers for biomedical applications, including biosensor and cell encapsulation applications. Michaels, A. S. Ind. Eng. Chem. 1965, 57, 32; Decher, G.; Lehr, B.; Lowack, K.; Lvov, Y.; Schmitt, J. Biosens. Bioelectron. 1994, 9, 677; Caruso, F.; Niikura, K.; Furlong, D. N.; Okahata, Y. Langmuir 1997, 13, 3427; Schneider, S.; Feilen, P. J.; Slotty, V.; Kampfner, D.; Preuss, S.; Berger, S.; Beyer, J.; Pommersheim, R. Biomaterials 2001, 22, 1961. Recently, some groups have investigated more specifically the interactions of multilayers with living cells. Chluba, J.; Voegel, J.-C.; Decher, G.; Erbacher, P.; Schaaf, P.; Ogier, J. Biomacromolecules 2001, 2, 800; Grant, G. G. S.; Koktysh, D. S.; Yun, B.; Matts, R. L.; Kotov, N. A. Biomed. Microdevices 2001, 3, 301; Serizawa, T.; Yamaguchi, M.; Matsuyama, T.; Akashi, M. Biomacromolecules 2000, 1, 306; Elbert, D. L.; Herbert, C. B.; Hubbell, J. A. Langmuir 1999, 15, 5355; Tryoen-Tóth, P.; Vautier, D.; Haikel, Y.; Voegel, J.-C.; Schaaf, P.; Chluba, J.; Ogier, J. J. Biomed. Mater. Res. 2002, 60, 657. For instance, it has been shown that melanoma cells could sense and respond to signaling hormone molecules immobilized within polylysine/polyglutamic acid multilayers, that muscle and neuronal precursor cells readily attached to collagen/sulfonated polystyrene (SPS) multilayers, and that, depending on whether chitosan or dextran sulfate was the outermost layer, multilayers assembled from those biopolymers alternately showed either pro- or anticoagulant properties, respectively, with human blood. Chluba, J.; Voegel, J.-C.; Decher, G.; Erbacher, P.; Schaaf, P.; Ogier, J. Biomacromolecules 2001, 2, 800; Grant, G. G. S.; Koktysh, D. S.; Yun, B.; Matts, R. L.; Kotov, N. A. Biomed. Microdevices 2001, 3, 301; Serizawa, T.; Yamaguchi, M.; Matsuyama, T.; Akashi, M. Biomacromolecules 2000, 1, 306. In addition, alginate/polylysine multilayers, when deposited onto otherwise cell-adhesive substrates, such as extracellular matrix (ECM), could render those surfaces cell resistant. Elbert, D. L.; Herbert, C. B.; Hubbell, J. A. Langmuir 1999, 15, 5355. The effect of the outermost surface layer of various multilayer systems on the in vitro response of osteoblasts has recently been investigated, as well. Tryoen-Tóth, P.; Vautier, D.; Haikel, Y.; Voegel, J.-C.; Schaaf, P.; Chluba, J.; Ogier, J. J. Biomed. Mater. Res. 2002, 60, 657.

Despite these studies, there still has been no systematic investigation of how cell behavior depends upon the molecular-level processing and structure of multilayers, features that are so inherently easily controlled in the layer-by-layer deposition approach. Moreover, using weak (i.e., pH-dependent) polyelectrolytes, such as the polycation poly(allylamine hydrochloride) (PAH) and the polyanion poly(acrylic acid) (PAA), enables one to fabricate a breadth of structurally-distinct multilayer systems by simply adjusting the deposition pH values of the polymer solutions. Shiratori, S. S.; Rubner, M. F. Macromolecules 2000, 33, 4213; Yoo, D.; Shiratori, S. S.; Rubner, M. F. Macromolecules 1998, 31, 4309. In this report, we describe the creation of new bioinert surfaces from multilayers assembled from PAH and PAA (as well as from other polyion combinations). Furthermore, we have more importantly discovered that by manipulating its underlying molecular structure, it is possible to direct a single multilayer combination to be either cytophilic (cell adhesive) or cytophobic (cell resistant) to a model murine NR6WT fibroblast cell line. In this manner, we thus demonstrate how cell adhesion to a synthetic polymeric surface may be quite powerfully switched “on” or “off,” simply by controlling the architecture rather than the identity of its constituent molecules. We also propose a general strategy by which to design a wide variety of bioinert and bioactive coatings, using virtually any synthetic and/or biological components as desired.

### SUMMARY OF THE INVENTION

One aspect of the present invention relates to a method of coating a surface, comprising sequentially depositing on a surface, under pH-controlled conditions, alternating layers of polymers to provide a coated surface, wherein a first polymer is selected from the group consisting of pH dependent cationic polyelectrolytes and neutral polymers, and a second polymer is selected from the group consisting of anionic polyelectrolytes, thereby permitting or preventing cell adhesion to said coated surface. In certain embodiments, the aforementioned method provides a coated surface to which cell adhesion is permitted. In certain embodiments, the aforementioned method provides a coated surface to which cell adhesion is prevented.

In certain embodiments of the method of the present invention, said first polymer is polyallylamine hydrochloride (PAH). In certain embodiments of the method of the present invention, said first polymer is polyacrylamide (PAAm). In certain embodiments of the method of the present invention, said second polymer is a pH dependent anionic polyelectrolyte. In certain embodiments of the method of the present invention, said second polymer is polyacrylic acid (PAA). In certain embodiments of the method of the present invention, said second polymer is polymethacrylic acid (PMA). In certain embodiments of the method of the present invention, said second polymer is poly(styrene sulfonate) (SPS).

In certain embodiments of the method of the present invention, said first polymer is PAH; and said second polymer is PAA. In certain embodiments of the method of the present invention, said first polymer is PAH; and said second polymer is PMA. In certain embodiments of the method of the present invention, said first polymer is PAAm; and said second polymer is PAA. In certain embodiments of the method of the present invention, said first polymer is PAAm; and said second polymer is PMA. In certain embodiments of the method of the present invention, said first polymer is PAH; and said second polymer is SPS.

In certain embodiments of the method of the present invention, said first polymer is a pH dependent cationic polyelectrolyte deposited at a pH between about 2.0 and about 2.5; and said second polymer is deposited at a pH between about 2.0 and about 2.5. In certain embodiments of the method of the present invention, said first polymer is PAH deposited at a pH between about 2.0 and about 2.5; and said second polymer is PAA deposited at a pH between about 2.0 and about 2.5. In certain embodiments of the method of the present invention, said first polymer is PAH deposited at a pH of about 2.5; and said second polymer is PAA deposited at a pH of about 2.5. In certain embodiments of the method of the present invention, said first polymer is a pH dependent cationic polyelectrolyte deposited at a pH of about 7.5; and said second polymer is PAA deposited at a pH of about 3.5. In certain embodiments of the method of the present invention, said first polymer is a pH dependent cationic polyelectrolyte deposited at a pH of about 6.5; and said second polymer is PAA deposited at a pH of about 6.5. In certain embodiments of the method of the present invention, said first polymer is a pH dependent cationic polyelectrolyte deposited at a pH of about 4.5; and said second polymer is PMA deposited at a pH of about 4.5. In certain embodiments of the method of the present invention, said first polymer is a pH dependent cationic polyelectrolyte deposited at a pH of about 6.5; and said second polymer is PMA deposited at a pH of about 6.5. In certain embodiments of the method of the present invention, said first polymer is PAH deposited at a pH of about 7.5; and said second polymer is PAA deposited at a pH of about 3.5. In certain embodiments of the method of the present invention, said first polymer is PAH deposited at a pH of about 6.5; and said second polymer is PAA deposited at a pH of about 6.5. In certain embodiments of the method of the present invention, said first polymer is PAH deposited at a pH of about 4.5; and said second polymer is PMA deposited at a pH of about 4.5. In certain embodiments of the method of the present invention, said first polymer is PAH deposited at a pH of about 6.5; and said second polymer is PMA deposited at a pH of about 6.5.

In certain embodiments of the method of the present invention, said first polymer is PAAm deposited at a pH between about 2.5 and about 3.5; and said second polymer is PAA deposited at a pH between about 2.5 and about 3.5. In certain embodiments of the method of the present invention, said first polymer is PAAm deposited at a pH between about 2.5 and about 3.5; and said second polymer is PMA deposited at a pH between about 2.5 and about 3.5. In certain embodiments of the method of the present invention, said first polymer is PAAm deposited at a pH of about 3.0; and said second polymer is PAA deposited at a pH of about 3.0. In certain embodiments of the method of the present invention, said first polymer is PAAm deposited at a pH of about 3.0; and said second polymer is PMA deposited at a pH of about 3.0. In certain embodiments of the method of the present invention, the method further comprises heating the coated surface at about 95° C. for about 8-12 hours.

Another aspect of the present invention relates to an article coated according to a method of the present invention. In certain embodiments, an article coated according to a method of the present invention is selected from the group consisting of blood vessel stents, angioplasty balloons, vascular graft tubing, prosthetic blood vessels, vascular shunts, heart valves, artificial heart components, pacemakers, pacemaker electrodes, pacemaker leads, ventricular assist devices, contact lenses, intraocular lenses, sponges for tissue engineering, foams for tissue engineering, matrices for tissue engineering, scaffolds for tissue engineering, biomedical membranes, dialysis membranes, cell-encapsulating membranes, drug delivery reservoirs, drug delivery matrices, drug delivery pumps, catheters, tubing, cosmetic surgery prostheses, orthopedic prostheses, dental prostheses, wound dressings, sutures, soft tissue repair meshes, percutaneous devices, diagnostic biosensors, cellular arrays, cellular networks, microfluidic devices, and protein arrays.

Another aspect of the present invention relates to a method of rendering a surface cytophilic, comprising the step of coating a surface with a polyelectrolyte multilayer film, which film swells to less than or equal to about 150% of its original thickness when exposed to an aqueous medium.

Another aspect of the present invention relates to a method of rendering a surface cytophobic, comprising the step of coating a surface with a polyelectrolyte multilayer film, which film swells to greater than or equal to about 200% of its original thickness when exposed to an aqueous medium.

A further aspect of the present invention relates to an article whose surface is rendered cytophilic from a method comprising the step of coating a surface with a polyelectrolyte multilayer film, which film swells to less than or equal to about 150% of its original thickness when exposed to an aqueous medium.

A further aspect of the present invention relates to an article whose surface is rendered cytophobic from a method comprising the step of coating a surface with a polyelectrolyte multilayer film, which film swells to greater than or equal to about 200% of its original thickness when exposed to an aqueous medium.

A further aspect of the present invention relates to an article whose surface is rendered either cytophilic or cytophobic by the above methods, wherein said article is selected from the group consisting of blood vessel stents, angioplasty balloons, vascular graft tubing, prosthetic blood vessels, vascular shunts, heart valves, artificial heart components, pacemakers, pacemaker electrodes, pacemaker leads, ventricular assist devices, contact lenses, intraocular lenses, sponges for tissue engineering, foams for tissue engineering, matrices for tissue engineering, scaffolds for tissue engineering, biomedical membranes, dialysis membranes, cell-encapsulating membranes, drug delivery reservoirs, drug delivery matrices, drug delivery pumps, catheters, tubing, cosmetic surgery prostheses, orthopedic prostheses, dental prostheses, wound dressings, sutures, soft tissue repair meshes, percutaneous devices, diagnostic biosensors, cellular arrays, cellular networks, microfluidic devices, and protein arrays.

### BRIEF DESCRIPTION OF THE FIGURES

FIG. 1 depicts phase contrast microscopy pictures of tissue culture polystyrene surfaces (TCPSs), either untreated (control) or coated with various PAA/PAH multilayers, taken after 1, 3, and 5 days of exposure to NR6WT fibroblasts.

FIG. 2 depicts phase contrast microscopy pictures of tissue culture polystyrene surfaces (TCPSs), either untreated (control) or coated with various PAA/PAH multilayers, taken after 1, 3, and 5 days of exposure to NR6WT fibroblasts.

FIG. 3 depicts phase contrast microscopy pictures of tissue culture polystyrene surfaces (TCPSs), either untreated (control) or coated with various PAA/PAH multilayers, taken after 1, 3, and 5 days of exposure to NR6WT fibroblasts.

FIG. 4 depicts graphically the number of NR6WT fibroblasts on various TCPSs as a function of exposure time.

FIG. 5 depicts phase contrast microscopy pictures of tissue culture polystyrene surfaces (TCPSs), either untreated (control) or coated with various PMA/PAH multilayers, taken after 1, 3, and 5 days of exposure to NR6WT fibroblasts.

FIG. 6 depicts phase contrast microscopy pictures of tissue culture polystyrene surfaces (TCPSs), either untreated (control) or coated with various PMA/PAH multilayers, taken after 1, 3, and 5 days of exposure to NR6WT fibroblasts.

FIG. 7 depicts phase contrast microscopy pictures of tissue culture polystyrene surfaces (TCPSs), either untreated (control) or coated with various PMA/PAH multilayers, taken after 1, 3, and 5 days of exposure to NR6WT fibroblasts.

FIG. 8 depicts phase contrast microscopy pictures of tissue culture polystyrene surfaces (TCPSs), either untreated (control) or coated with various SPS/PAH multilayers, taken after 1, 3, and 5 days of exposure to NR6WT fibroblasts.

FIG. 9 depicts phase contrast microscopy pictures of tissue culture polystyrene surfaces (TCPSs), either untreated (control) or coated with various SPS/PAH multilayers, taken after 1, 3, and 5 days of exposure to NR6WT fibroblasts.

FIG. 10 depicts phase contrast microscopy pictures of tissue culture polystyrene surfaces (TCPSs), either untreated (control) or coated with various PAA/PAAm multilayers, taken after 1, 3, and 5 days of exposure to NR6WT fibroblasts.

FIG. 11 depicts phase contrast microscopy pictures of tissue culture polystyrene surfaces (TCPSs), either untreated (control) or coated with various PMA/PAAm multilayers, taken after 1, 3, and 5 days of exposure to NR6WT fibroblasts.

FIG. 12 depicts phase contrast microscopy pictures of various sections of a tissue culture polystyrene surface (TCPS), half of which has been coated with a PAA/PAAm multilayer, taken after 1 and 2 days of exposure to NR6WT fibroblasts.

FIG. 13 depicts schematics (a-c) of the 2.0/2.0, 7.5/3.5, and 6.5/6.5 PAH/PAA multilayer assemblies, respectively, shown with PAA as the outermost layer.

FIG. 14 depicts phase contrast micrographs acquired on day 3 of murine NR6WT fibroblasts seeded at 10,000 cells/cm² onto: (a) a 2.0/2.0 (20 layers), (b) a 7.5/3.5 (20 layers), and (c) a 6.5/6.5 (50 layers) PAH/PAA multilayer, and (d) a TCPS control; (e) cells transplanted to a TCPS control after remaining suspended for 2 days in the culture media on a bioinert 2.0/2.0 PAH/PAA multilayer. (bar=200 μm).

FIG. 15 depicts phase contrast micrographs from day 1 of NR6WT fibroblasts seeded onto x layers of the inert (PAH/PAA)_{2.0/2.0} system assembled onto a 40 layer cytophilic (PAH/PAA)_{6.5/6.5} base film, where x equals: (a) 0 layers, (b) 1 layer, (c) 11 layers, (d) 21 layers. Phase contrast micrographs from day 1 of fibroblasts seeded onto x layers of (PAH/PAA)_{6.5/6.5} assembled onto a 20 layer cytophobic (PAH/PAA)_{2.0/2.0} base, where x equals: (e) 0 layers, (f) 1 layer, (g) 11 layers, (h) 21 layers. (bar=200 μm).

FIG. 16 depicts SPR-derived adsorption data for lysozyme and fibrinogen on an uncoated gold surface and on gold coated with 10/11 layers of the the cytophilic 7.5/3.5 or 14/15 layers of the cytophobic 2.0/2.0 PAH/PAA multilayer system. (Black bars correspond to lysozyme; gray bars signify fibrinogen.)

FIG. 17 depicts phase contrast micrographs acquired on day 3 of murine NR6WT fibroblasts seeded at 10,000 cells/cm² onto PAH/PMA multilayers assembled at pH deposition conditions of: (a) 2.5/2.5 (24 layers), (b) 4.5/4.5(24 layers), and (c) 6.5/6.5 (46 layers). (bar=200 μm)

FIG. 18 depicts phase contrast micrographs acquired on day 3 of murine NR6WT fibroblasts seeded at 10,000 cells/cm² onto PAH/SPS multilayers assembled at pH deposition conditions of: (a) 2.0/2.0 (50 layers), (b) 6.5/6.5 (50layers) and (c) 10.0/10.0 (20 layers). (bar=200 μm)

FIG. 19 depicts phase contrast micrographs acquired on day 3 of murine NR6WT fibroblasts seeded at 10,000 cells/cm² onto PDAC/SPS multilayers assembled: (a) without (50 layers) and (b) with 0.25 M NaCl (20 layers). (bar=200 μm)

FIG. 20 depicts % swelling in buffer (PBS, pH˜7.4) relative to the initial dry film thickness exhibited by various multilayer systems. These measurements were acquired using in-situ AFM on samples ending with the cationic polymer (i.e., PAH or PDAC). Here, % swelling is defined as the swollen thickness in buffer relative to the dry (in air) thickness×100%. (Black bars correspond to cytophobic multilayers; gray bars signify cytophilic multilayers). The number of layers was 21 for PAH/PAA 2.0/2.0 and 7.5/3.5, 171 for PAH/PAA 6.5/6.5, 95 for PAH/SPS 2.0/2.0, 179 for PAH/SPS 6.5/6.5, 157 for PDAC/SPS 6.5/6.5 and 21 for PDAC/SPS 6.5/6.5 with added salt.

### DETAILED DESCRIPTION OF THE INVENTION

We present a versatile approach to fabricating uniform bioinert surfaces from virtually any polyionic material, even ones recognized to encourage protein and cell attachment. Using polyelectrolyte multilayer deposition, this strategy assembles uniform, highly interpenetrated ultrathin nanocomposite films one molecular layer at a time from the repetitive, alternative adsorption of oppositely charged polyelectrolytes from dilute aqueous solution. See Decher, G. Science 1997, 277, 1232; Hammond, P. T. Curr. Opin. Colloid Interface Sci. 2000, 430. Our approach offers unprecedented nanoscale control over the thin film architecture and properties, including film thickness, composition, conformation, degree of interchain ionic bonding, roughness, and wettability. See Shiratori, S. S.; Rubner, M. F. Macromolecules 2000, 33, 4213. Advantageously, the resulting films can conformally to substrate materials of any type, size, or shape (including implants with complex geometries and textures, e.g., stents and crimped blood vessel prostheses). Furthermore, a variety of materials, including synthetic polyions, biopolymers such as DNA and enzymes, viruses, dendrimers, colloids, inorganic particles, and dyes, may be readily incorporated into the multilayers. See Decher, G. Science 1997, 277, 1232.

This layer-by-layer deposition process provides a means to create polycation-polyanion polyelectrolyte multilayers one molecular layer at a time, thereby allowing an unprecedented level of control over the composition and surface functionality of these interesting materials. Typically, alternate layers of positively and negatively charged polymers are sequentially adsorbed onto a substrate from dilute solution to build up interpenetrated multilayer structures. Most studies have focused on polyelectrolytes in their fully charged state, such as strong polyelectrolyte poly(styrene sulfonate) (SPS). However, we have discovered unique properties when at least one alternating layer in the polyelectrolyte multilayer is a weak polyelectrolyte where the charge density along the chain can be readily controlled by adjusting the pH values of the polyelectrolyte solution. Consequently, it would be desirable to develop new bio-inert materials based on polyelectrolyte multilayers with tunable properties.

Using a highly customizable thin film fabrication strategy, we assembled various nanostructured polyelectrolyte multilayers that would either enable or resist the attachment of NR6WT fibroblasts, a model adhesive cell line. Even if assembled from a single polyion combination pair, multilayers could be effectively tuned to be either cytophilic or cytophobic. The only definitive difference between a cytophilic multilayer (e.g., 7.5/3.5 PAH/PAA) and its cytophobic counterpart (2.0/2.0 PAH/PAA) was simply their molecular architecture, with rather negligible differences between their protein adsorption or wettability characteristics. In fact, all of the representative pH-sensitive and salt-containing systems that resisted cell attachment shared the common aspect of having a lightly ionically crosslinked structure; cytophilic films, in contrast, exhibited densely ionically stitched architectures. This structural attribute was shown to greatly influence the ability of films to swell and hydrate under buffered physiological conditions, with the weakly ionically crosslinked films being able to swell substantially and subsequently resist cell attachment. The lack of an outermost layer effect also suggests that overall film swelling rather than any one surface property is the key element to bioinertness. The fact that protein adhesion occurs on both cytophilic and cytophobic multilayers is not surprising, given the numerous examples in the polyelectrolyte literature in which proteins easily adsorb onto many different multilayer surfaces, even to similarly-charged surfaces. Furthermore, observations that such proteins often remain stabilized in their globular, non-denatured forms help to explain why even the cytophobic 2.0/2.0 PAH/PAA system, which does attract proteins, can still resist cell attachment. Quite significantly, this study has additionally provided a design paradigm by which to fabricate desired, predictable, and engineered cell-materials interactions from nano-structured thin films using a wide range of constituent polymers—controlling the multilayer processing conditions allows the film's ionic architecture to be fined-tuned, which then dictates its degree of hydration and swelling and ultimately how cell adhesion to that multilayer may be switched “on” or “off.”

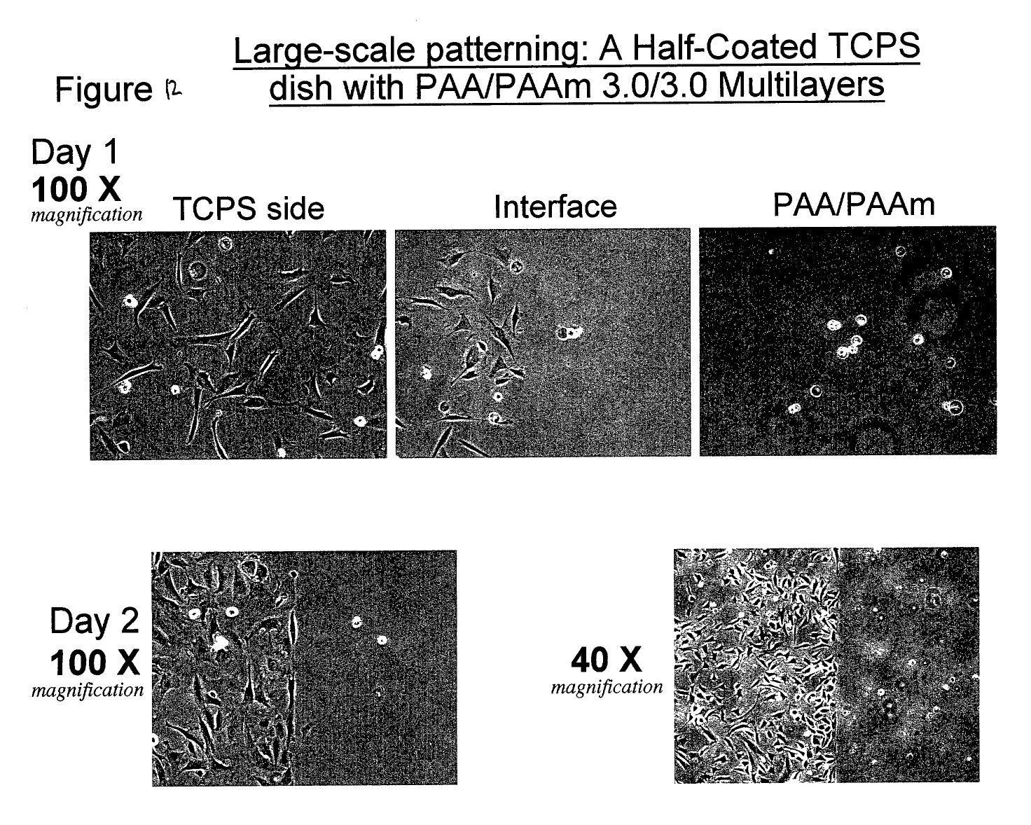

A wide range of cell-interactive surfaces based on simple polyelectrolyte multilayer schemes have now been identified: bioactive multilayer films that attract cells, including PMA- or PAA-/PAH systems assembled at higher pH conditions and SPS/PAH films, and bio-inert materials that greatly resist non-specific cell adhesion, including the PMA- or PAA-/PAAm combinations and PMA- or PAA-/PAH systems fabricated at low pH values. After surveying the general cell response to various multilayer assemblies, it is possible to further exploit the rich opportunities provided by polyelectrolyte multilayers. For instance, due to the ease in the microscale patterning of multilayer thin films, it will be quite feasible to create heterostructured bio-interfaces exhibiting precisely positioned cell-adhesive and cell-resistant multilayers. As preliminary evidence of the patterning of multilayers for controlling bio-interfaces, FIG. 12 shows a normally highly cell-adhesive TCPS surface that was half-coated with bio-inert PAA/PAAm multilayers; it is clear that cells only bind to the adherent TCPS side and remain floating and unattached to the cell-resistant multilayer half.

Furthermore, the capability to present on bio-inert multilayers a variety of cell-adhesive biomolecules, e.g., fibronectin or the RGD (arginine-glycine-aspartic acid) amino acid sequence, via several different approaches should also expand the versatility of polyelectrolyte multilayers for bio-interface materials. For example, it should be quite facile to chemically modify the functional groups of PAA, PMA, or PAH to tether these specific cell-adhesion proteins. Thus, it should be possible to have, for example, an RGD-modified 2.0/2.0 PAA/PAH film whereby the multilayer presents a bio-inert background, and the RGD component enables the controlled binding of cells. Such micropatterning of cell-adhesive and -resistant features on a surface should provide opportunities for making cellular networks and arrays as well as biosensors. Furthermore, because the polyelectrolytes used to assemble multilayers are in solution, the polymers are able to flow into tiny, intricate geometries, such as the common medical devices of cardiovascular stents and synthetic blood vessel prostheses; multilayers could then easily be created to fabricate conformal coatings with highly tailored structural features as well as predictable, favorable interactions with living cells.

Specific examples of articles that may be advantageously coated according to the methods of the present invention include blood vessel stents, angioplasty balloons, vascular graft tubing, prosthetic blood vessels, vascular shunts, heart valves, artificial heart components, pacemakers, pacemaker electrodes, pacemaker leads, ventricular assist devices, contact lenses, intraocular lenses, sponges for tissue engineering, foams for tissue engineering, matrices for tissue engineering, scaffolds for tissue engineering, biomedical membranes, dialysis membranes, cell-encapsulating membranes, drug delivery reservoirs, drug delivery matrices, drug delivery pumps, catheters, tubing, cosmetic surgery prostheses, orthopedic prostheses, dental prostheses, wound dressings, sutures, soft tissue repair meshes, percutaneous devices, diagnostic biosensors, cellular arrays, cellular networks, microfluidic devices, and protein arrays.

Yet another advantage of the methods of the present invention is that the polymer solutions used to deposit the alternating layers of the polyelectrolyte multilayer are aqueous solutions, thus making large scale production of the present invention environmentally friendly and free of the handling and regulation problems associated with non-aqueous solvents.

Overall, polyelectrolyte multilayers should greatly expand the possibilities for controlling cell-biomaterial interactions. With the versatility of this technique, it is possible to assemble complex heterostructured multilayer thin films comprising: synthetic polyions that may be conductive or electroactive; nanoparticles that may be antibacterial; biopolymers, such as enzymes, that have bio-sensing capabilities; or cell-resistant (e.g., PAA/PAAm or 2.0/2.0 PAA/PAH) components; all of which may be micropatterned. For instance, the polyelectrolyte multilayers of the present invention can be utilized as nanoreactors for both silver (Ag, a metal) and lead sulfide (PbS, a semiconductor) nanoparticles, achieving spatial control at the nanoscale over the growth of the nanoparticles. See Rubner, M. F. et al., Langmuir 2000, 16, 1354-59. We envision that the same studies performed with polyelectrolyte hydrogels will be equally applicable to our polyelectrolyte multilayers but with the added advantage of greater control over the physical and chemical properties of the multilayer not found with the hydrogel complex. See Rubner, M. F. et al., Macromolecules 1998, 31, 4309-18; Rubner, M. F. et al., Macromolecules 2000, 33, 4213-19; and Rubner, M. F. et al., Langmuir 2000, 16, 5017-23. Such applications include encapsulating cell products, drugs, or enzymes for novel therapeutic purposes, such as cell-based internal artificial organs and as a potential treatment for many ailments, including diabetes, neurological conditions, and chronic pain. Thus, we envision this invention—polyelectrolyte multilayers being used to create bio-inert and/or cell-interactive surfaces—as a new nanoscale-processed alternative for effectively engineering bio-interfaces with controlled cell behavior.

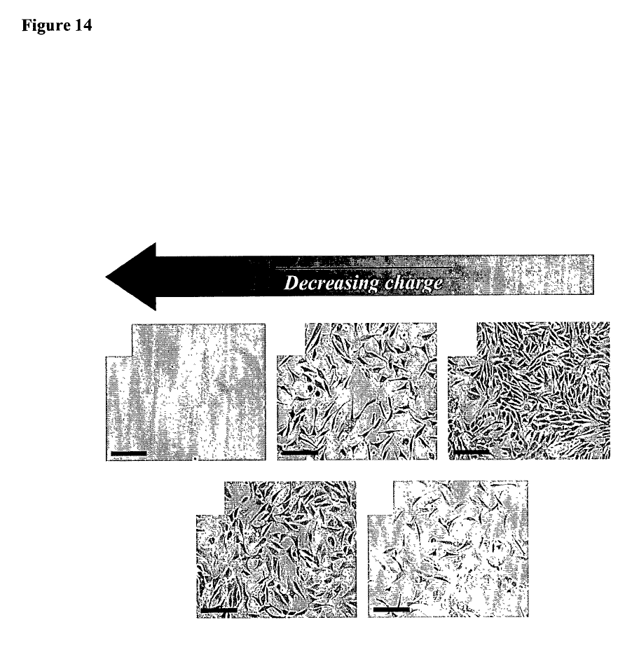

Using a molecular-level layer-by-layer approach, a variety of nanostructured thin films were assembled from some common polyelectrolytes and then examined for their biocompatibility, notably their ability to adhere mammalian fibroblasts. Understanding and manipulating these weak polyelectrolyte multilayers has previously led to opportunities for pH-triggered controlled release, microporous and nanoporous thin films, selective block copolymer adsorption, and selective electroless metal deposition, among other applications. Chung, A. J.; Rubner, M. F. Langmuir 2002, 18, 1176; Mendelsohn, J. D.; Barrett, C. J.; Chan, V. V.; Pal, A. J.; Mayes, A. M.; Rubner, M. F. Langmuir 2000, 16, 5017; Hiller, J.; Mendelsohn, J. D.; Rubner, M. F. Nature Materials, 2002, 1, 59; Choi, J.; Rubner, M. F. J. Macromol. Sci.—Pure Appl. Chem. 2001, A38, 1191; Wang, T. C.; Chen, B.; Rubner, M. F.; Cohen, R. E. Langmuir 2001, 17, 6610. As FIGS. 14 and 17-19 clearly indicate, we now demonstrate that it is possible to create several pH-tunable multilayer structures to which cell adhesion could quite powerfully be turned “on” or “off.” First, by adjusting the pH to lower the charge density of the carboxylic-acid containing polymers of PAA and PMA, we constructed lightly ionically crosslinked multilayer films that effectively resisted cell attachment. In contrast, at pH deposition conditions where the polyions were more fully-charged and arranged in densely ionically stitched conformations, we fabricated cytophilic thin films, which enabled the fibroblasts to attach, spread, and proliferate in a manner similar to that observed on a TCPS control.

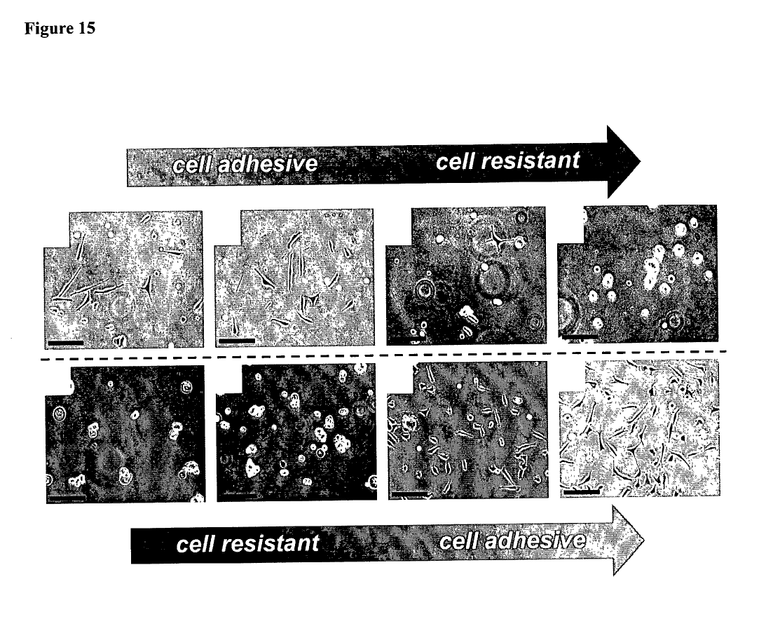

After analyzing how the ionic nano-architecture of PAH/-PAA or -PMA multilayers could dictate cell responses, we then understood how to assemble films from PAH and the strong polyion SPS to achieve controlled cell responses. Quite analogously, PAH/SPS films built with tightly ionically crosslinked structures were cytophilic, while loosely ionically stitched films, fabricated under basic pH conditions to yield only slightly charged PAH chains, were cytophobic. Similar results of cytophilicity and cytophobicity were obtained when two strong polyions, SPS and PDAC, were assembled without salt into highly ionically crosslinked structures and with added salt into ion-shielded conformations, respectively. Thus, by adjusting the ionic strength and/or pH to control the underlying molecular film architecture, we created tailorable cell-interactive materials on demand. As FIG. 15 demonstrated, it is also possible to exploit the layer-by-layer process to engineer hetero-structured multilayers whereby cytophilic layers may mask the effects of underlying cytophobic layers and vice versa.

It is generally understood that many materials are either intrinsically bioinert or not. For instance, PEO and its related hydrogels are overall considered to be bioinert, yet such materials may be made cell adherent if modified with appropriate chemical groups or bioadhesive ligands. In fact, carboxylic acid, sulfonate, and hydroxyl functionalities, among others, often are employed to render such otherwise inert materials cytophilic. Ghosh, P.; Amirpour, M. L.; Lackowski, W. M.; Pishko, M. V.; Crooks, R. M. Angew. Chem. Int. Ed. 1999, 38, 1592. Consequently, many of the polymers (and their individual functional groups) discussed here are naturally cell adhesive. For instance, PAH and amine groups have been reported to be quite protein and cell adhesive. Chapman, R. G.; Ostuni, E.; Liang, M. N.; Meluleni, G.; Kim, E.; Yan, L.; Pier, G.; Warren, H. S.; Whitesides, G. M. Langmuir 2001, 17, 1225. Similarly, the ionizable COOH group, the chemical functionality found in PAA and PMA, is often employed to encourage cell binding to hydrogels, such as poly(hydroxyethyl methacrylate), which do not generally support cell attachment. McAuslan, B. R.; Johnson, G. J. Biomed. Mater. Res. 1987, 21, 921; Ramsey, W. S.; Hertl, W.; Nowlan, E. D.; Binkowski, N. J. In Vitro 1984, 20, 802; Shivakumar, K.; Nair, R. R.; Jayakrishnan, A.; Thanoo, B. C.; Kartha, C. C. In Vitro Cell. Devel. Biol. 1989, 25, 353. Ghosh et. al have reported that hyperbranched PAA films were cell adhesive due to their carboxylic acids, but that grafting PEO to the PAA was required in order to render the films cell resistant. Ghosh, P.; Amirpour, M. L.; Lackowski, W. M.; Pishko, M. V.; Crooks, R. M. Angew. Chem. Int. Ed. 1999, 38, 1592. Modifying surfaces with SAMs of alkanethiols with COOH terminus groups has also frequently been used to enhance cell adhesion. López, G. P.; Albers, M. W.; Schreiber, S. L.; Carroll, R.; Peralta, E.; Whitesides, G. M. J. Am. Chem. Soc. 1993, 115, 5877; Cooper, E.; Parker, L.; Scotchford, C. A.; Downes, S.; Leggett, G. J.; Parker, T. L. J. Mater. Chem. 2000, 10, 133; Tidwell, C. D.; Ertel, S. I.; Ratner, B. D.; Tarasevich, B. J.; Arte, S.; Allara, D. L. Langmuir 1997, 13, 3404. Furthermore, in general, PAA is well known as a bioadhesive and, specifically, a mucoadhesive polymer, since its carboxylic acid groups can readily bind with divalent ions (e.g., Ca²⁺) in mucus linings within the body. Peppas, N. A.; Sahlin, J. J. Biomaterials 1996, 17, 1553. Therefore, using surface modification processes such as chemical grafting or SAMs, as demonstrated in these examples, limits the behavior of these polyelectrolytes to be only cell adhesive. In contrast, polyelectrolyte multilayer processing provides a much richer and versatile strategy to develop bio-interactive coatings whereby the cell adhesiveness of a multilayer is tuned at will. Thus, although such polymers as PAH and PAA are individually often cited as being cytophilic, that premise may certainly not be valid when the polymers are assembled into multilayers. To our knowledge, this report is the first demonstration that molecular blends of two (or more) polymers can be directed to be either cell adhesive or resistant, even if the constituent polyions are themselves reported to be cell adhesive.

Currently, there are no general, comprehensive rules by which to predict whether or not a material will be cell resistant. In fact, many routinely measurable surface properties, such as wettability, charge and polarity, topography, and protein adhesion do not seem to correlate well with how a material will interact with cells. Ostuni, E.; Chapman, R. G.; Liang, M. N.; Meluleni, G.; Pier, G.; Ingber, D. E.; Whitesides, G. M. Langmuir 2001, 17, 6336; Chapman, R. G.; Ostuni, E.; Takayama, S.; Holmlin, R. E.; Yan, L.; Whitesides, G. M. J. Am. Chem. Soc. 2000, 122, 8303. The observations revealed here concerning the attachment of a highly adhesive fibroblast cell line to polyelectrolyte multilayer thin films also do not identify any obvious correlation between such parameters as surface charge, wettability, or protein adsorption and the ability for certain films to resist cell adhesion. Interestingly enough, there was no outermost layer effect—a specific multilayer combination was always either cytophilic or cytophobic, irrespective of its terminating polymeric identity or net surface charge. Although the identity of the outermost layer in polyelectrolyte multilayer films has, at times, been found to greatly influence biological responses, these studies do not find any such differences; instead, these results suggest that not just the nature of the surface but rather the entire multilayer is responsible for its interactions with living cells. Serizawa, T.; Yamaguchi, M.; Matsuyama, T.; Akashi, M. Biomacromolecules 2000, 1, 306; Tryoen-Tóth, P.; Vautier, D.; Haikel, Y.; Voegel, J.-C.; Schaaf, P.; Chluba, J.; Ogier, J. J. Biomed. Mater. Res. 2002, 60, 657.

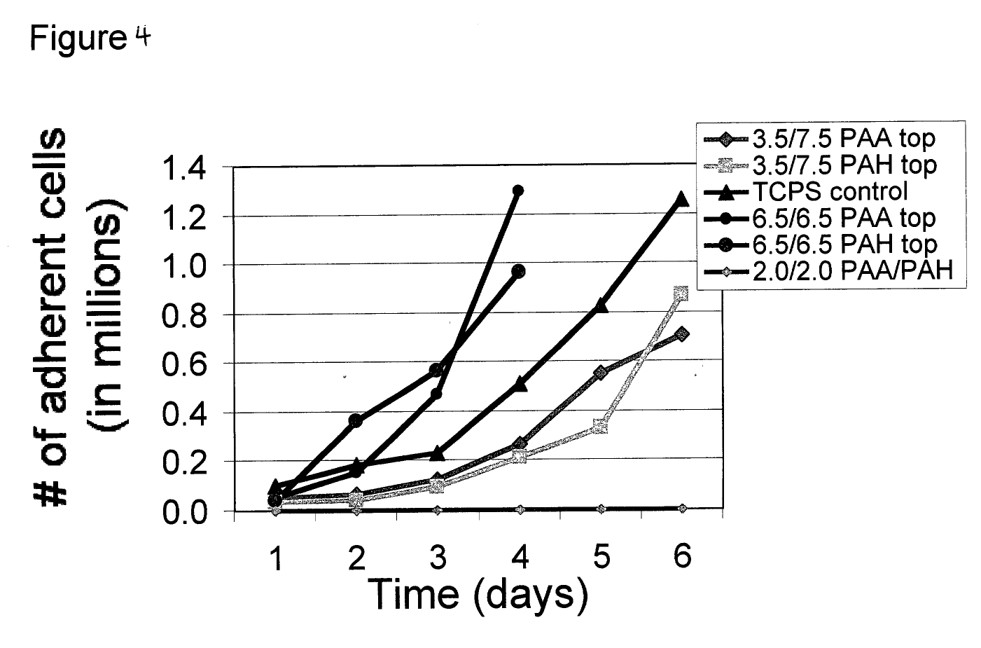

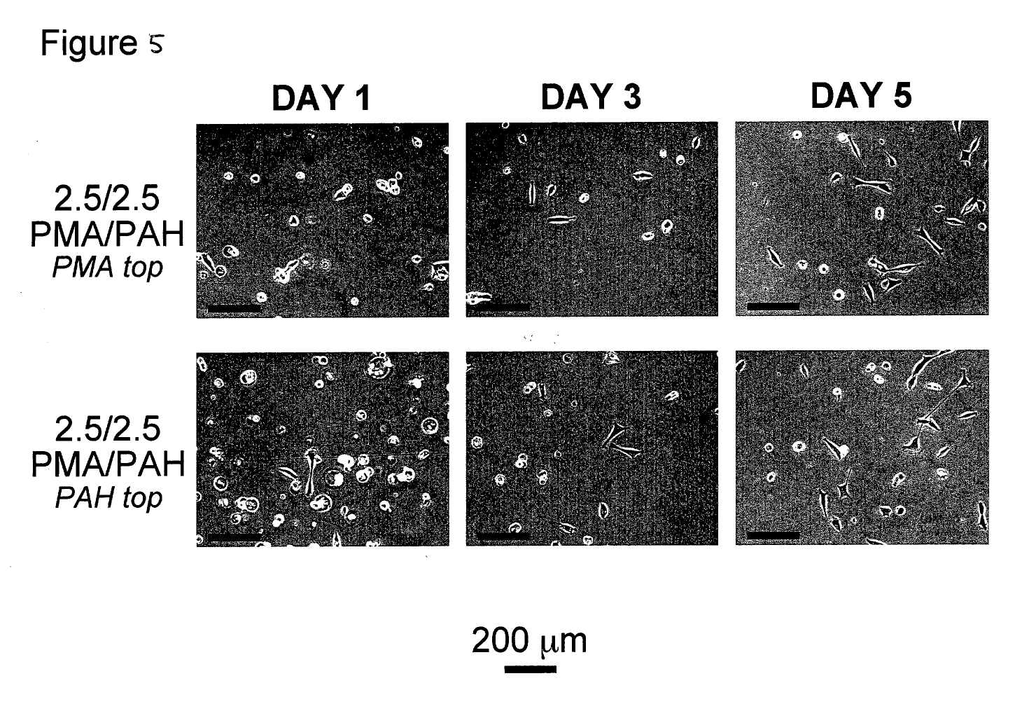

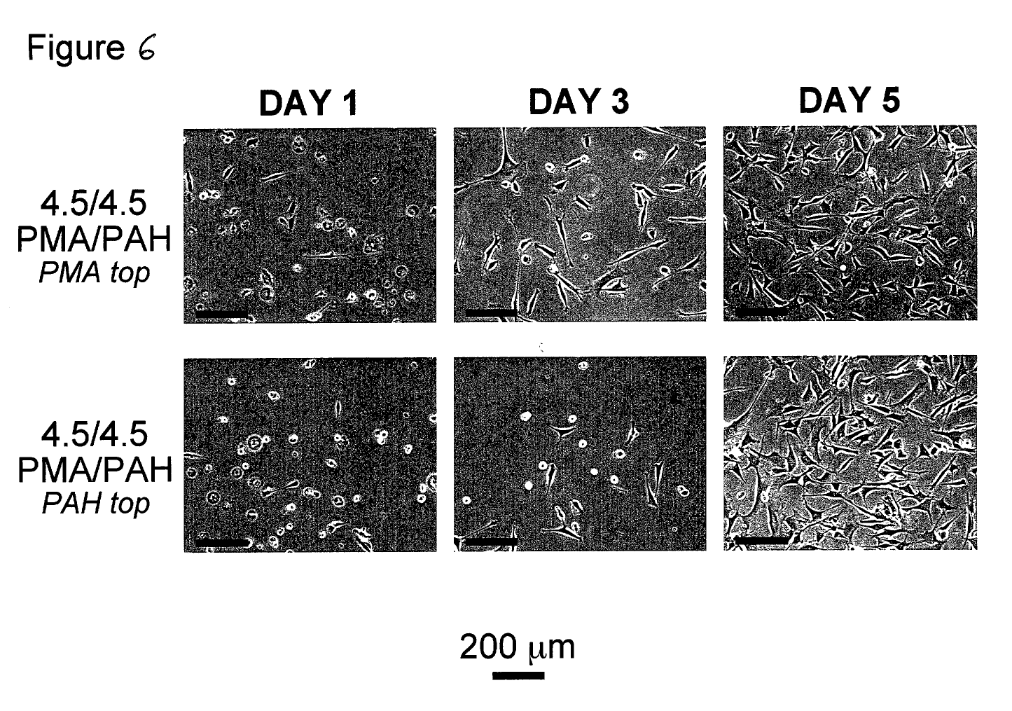

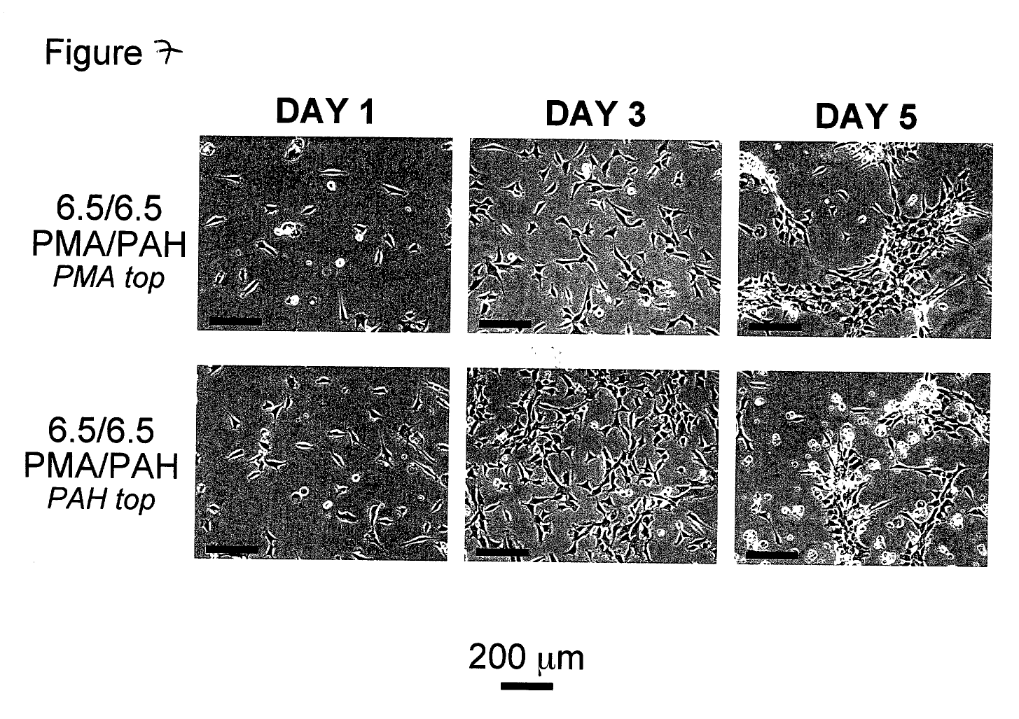

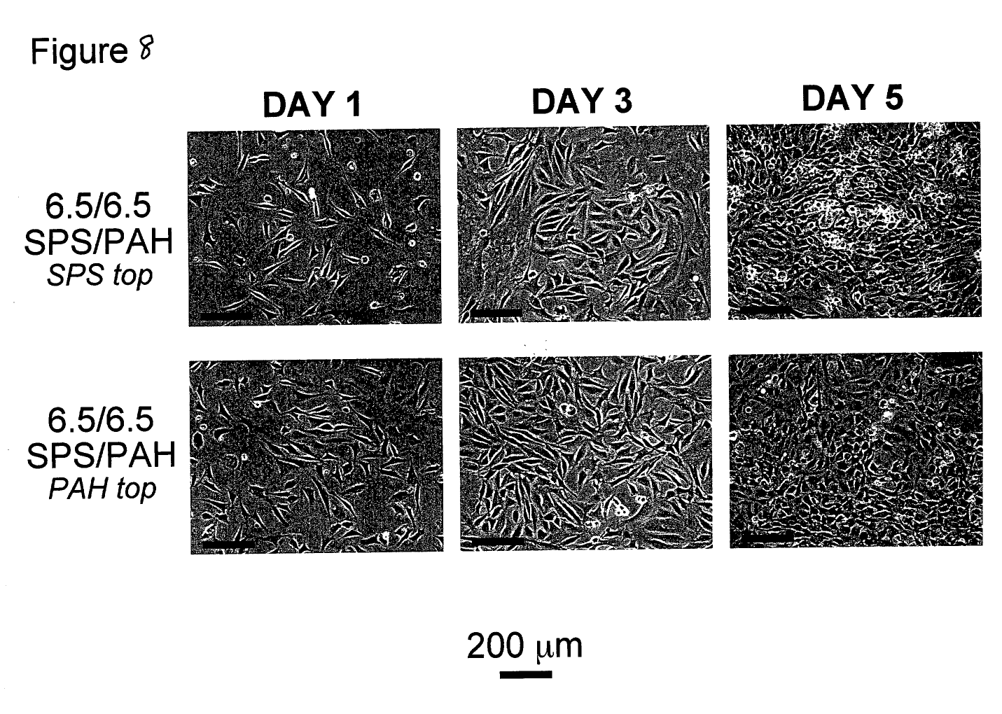

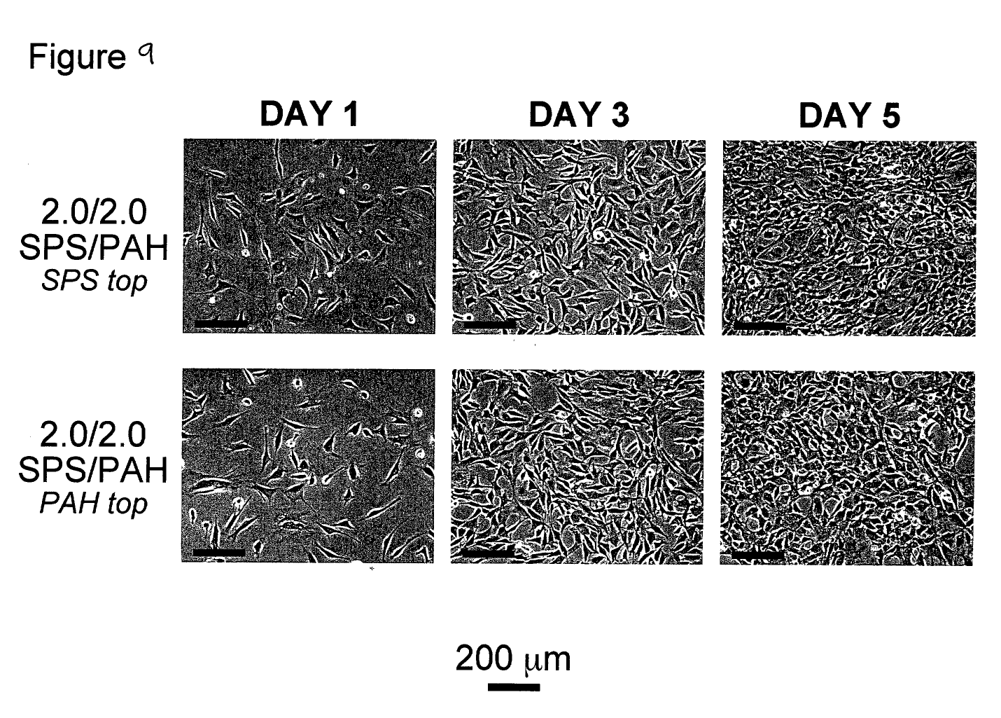

Although not providing a definitive explanation as to why an individual film would either attract or resist cells, protein adsorption studies were still useful in elucidating the overall biocompatibility of polyelectrolyte multilayers. Numerous reports in the polyelectrolyte multilayer field investigating the assembly of hybrid protein-containing films have previously demonstrated how virtually any protein could readily adsorb onto an oppositely charged polyion and even onto a similarly charged polymer, although usually to a lesser degree. Lvov, Y.; Ariga, K.; Ichinose, I.; Kunitake, T. J. Am. Chem. Soc. 1995, 117, 6117; Ladam, G.; Gergely, C.; Senger, B.; Decher, G.; Voegel, J.-C.; Schaaf, P.; Cuisinier, F. J. G. Biomacromolecules 2000, 1, 674; Ladam, G.; Schaaf, P.; Cuisinier, F. J. G.; Decher, G.; Voegel, J.-C. Langmuir 2001, 17, 878. Thus, it is not too surprising that the 2.0/2.0 and the 7.5/3.5 PAH/PAA multilayers, irrespectively of the net surface charge, both attracted to some extent the predominantly cationic lysozyme and the overall anionic fibrinogen in a physiologically nonspecific manner. The SPR-acquired adsorbed amounts of each protein onto the individual multilayer systems, as presented in FIG. 4, are consistent with the fact that electrostatic interactions, along with other secondary interactions and the overall multifaceted character of proteins, enable the binding of proteins to many different synthetic surfaces. In fact, the multilayer surfaces that are rich in unpaired COOH groups—the 7.5/3.5 PAH/PAA combination ending with PAA and the 2.0/2.0 PAH/PAA system terminating with either PAA or PAH—adsorbed the highly cationic lysozyme more than the anionic fibrinogen. These findings are not surprisingly, given that the COOH groups ionize in physiological buffer to yield COO⁻-rich surfaces, readily capable of binding the oppositely charged lysozyme.

Clearly, the above results revealed that neither the cell resistant nor the cell adhesive multilayer combinations were protein resistant. However, relative to plain gold, all multilayers significantly abated the nonspecific adsorption of the model cell adhesive protein fibrinogen. Interestingly, SPR analysis revealed that the cytophobic 2.0/2.0 PAH/PAA multilayers were even more protein adhesive overall than the cytophilic 7.5/3.5 PAH/PAA system. Since cell attachment is mediated via proteins (e.g., integrins and adhesion molecules), researchers often draw conclusions between a material's ability to be protein resistant and its potential to be cell resistant, and vice versa. Elbert, D. L.; Hubbell, J. A. Annu. Rev. Mater. Sci. 1996, 26, 365. However, the correlation between protein and cell adhesion is relatively poor and still not well understood. Ostuni, E.; Chapman, R. G.; Liang, M. N.; Meluleni, G.; Pier, G.; Ingber, D. E.; Whitesides, G. M. Langmuir 2001, 17, 6336; Tidwell, C. D.; Ertel, S. I.; Ratner, B. D.; Tarasevich, B. J.; Arte, S.; Allara, D. L. Langmuir 1997, 13, 3404. For example, recent studies found no relationship between protein resistant SAMs of alkanethiols, terminated with a variety of chemical groups, and their ability to be cell resistant. Ostuni, E.; Chapman, R. G.; Liang, M. N.; Meluleni, G.; Pier, G.; Ingber, D. E.; Whitesides, G. M. Langmuir 2001, 17, 6336. Furthermore, some SAMs have been reported to bind fibrinogen yet remain essentially cell resistant, an observation found with the 2.0/2.0 PAH/PAA combination, as well. Ostuni, E.; Chapman, R. G.; Liang, M. N.; Meluleni, G.; Pier, G.; Ingber, D. E.; Whitesides, G. M. Langmuir 2001, 17, 6336. Factors such as the strength of protein binding and the adsorption of proteins in conformations that are unsupportive of subsequent cell attachment have been provided as some reasons why an adsorbed cell-adhesive protein would not encourage cell binding. Tidwell, C. D.; Ertel, S. I.; Ratner, B. D.; Tarasevich, B. J.; Arte, S.; Allara, D. L. Langmuir 1997, 13, 3404.

As seen in the above example multilayer combinations, the molecular architecture and the ability to swell under buffered physiological conditions were the only striking distinguishing elements between whether a multilayer would be cytophilic or cytophobic. All of the representative polyelectrolyte multilayers systems described here share a structural-dependence in their interactions with the NR6WT fibroblasts—highly ionically crosslinked films were cytophilic, while weakly ionically stitched conformations were cytophobic. As seen in FIG. 8, these distinct ionic architectures manifested as sizeable differences in the ability of an individual film to swell in buffered conditions; the cytophobic multilayers hydrated considerably more than their cytophilic counterparts, as revealed by in-situ AFM measurements. It is well known that polyelectrolyte multilayers are inherently hydrated assemblies, although the amount of hydration may vary considerably depending on such parameters as the ionic strength of the polyion deposition solutions and the specific polyions used. Dubas, S. T.; Schlenoff, J. B. Langmuir 2001, 17, 7725; Lösche, M.; Schmitt, J.; Decher, G.; Bouwman, W. G.; Kjaer, K. Macromolecules 1998, 31, 8893; Farhat, T.; Yassin, G.; Dubas, S. T.; Schlenoff, J. B. Langmuir 1999, 15, 6621. Thus, upon exposure to salt-containing solutions (e.g., the buffered cell culture media or PBS), the incorporation of salt ions and accompanying waters of hydration²⁹ would swell the multilayers to various degrees. Dubas, S. T.; Schlenoff, J. B. Langmuir 2001, 17, 7725. For instance, the as-prepared 2.0/2.0 PAH/PAA film contains many unpaired COOH groups, which ionize in buffer; the abundance of the numerous similarly charged COO⁻ groups would repel each other and consequently the induce substantial film swelling. By analogy, the 10.0/10.0 PAH/SPS films, possessing many uncharged amines, which protonate to NH₃⁺ in buffer, would be expected to swell due to charge repulsion, as well.

The interaction of a biomaterial surface with water is known to be an essential component of biocompatibility. Vogler, E. A. Adv. Colloid Interface Sci. 1998, 74, 69; Morra, M. J. Biomater. Sci. Polym. Ed. 2000, 11, 547. Based on theoretical and experimental studies with the known protein resistant materials of PEO and o-EG, it is generally believed that having conformations that induce highly favorable interactions with water is necessary for the bioinertness of a material or surface. Wang, R. L. C.; Kreuzer, H. J.; Grunze, M. J. Phys. Chem. B 1997, 101, 9767; Malmsten, M.; Emoto, K.; Van Alstine, J. M. V. J. Colloid Interface Sci. 1998, 202, 507. The strong association of water around such materials then sterically inhibits protein and cell attachment. Clearly, the substantial swelling and hydration of the cytophobic multilayer combinations similarly rendered cell resistance. Elbert et al. previously explained that multilayers assembled from alginate/polylysine were cell resistant, because the films were inherently well hydrated and that both biopolymers have already exhibited some bioinertness, particularly in their historical use as complex coacervates for cell encapsulation. Elbert, D. L.; Herbert, C. B.; Hubbell, J. A. Langmuir 1999, 15, 5355. By further manipulating the ionic architecture of a multilayer film, as we demonstrated here, it is possible to effectively control the degree of that intrinsic hydration and swelling to subsequently either attract or repel cells. As the hetero-structure multilayer example of 6.5/6.5 PAH/PAA assembled onto 2.0/2.0 PAH/PAA layers also revealed (FIG. 15), swelling is the crucial component of the fibroblasts response. Even a cytophobic 2.0/2.0 PAH/PAA film can be rendered cytophilic when its swelling is greatly diminished by the addition of relatively non-swellable 6.5/6.5 PAH/PAA layers.

Although the complex interplay between protein and cell adhesion is not completely understood, it is intriguing that the cytophobic 2.0/2.0 multilayer adsorbed more lysozyme and fibrinogen than the cytophilic 7.5/3.5 PAH/PAA system. Exhibiting a highly swellable, water-rich character, the 2.0/2.0 multilayers presumably do not allow serum proteins to denature in order to support cell adhesion. From the cells' perspective, the proteins essentially appear to be dissolved in the buffer rather than be anchored on a surface, which would be necessary for promoting cell attachment. In fact, it is known that polyelectrolytes tend to stabilize proteins in general and that proteins may be assembled in their native, globular, non-denatured states within or on the surfaces of multilayers. Schwinté, P.; Voegel, J.-C.; Picart, C.; Haikel, Y.; Schaaf, P.; Szalontai, B. J. Phys. Chem. B 2001, 105, 11906. Thus, although able to attract proteins, the swollen and hydrated 2.0/2.0 PAH/PAA multilayers are too gel-like and would appear to be no different than water to the cells. Similarly, the other highly hydrated, cytophobic multilayers (e.g., PAH/SPS at 10.0/10.0) would look too watery to the cells and thus appear to be unfavorable for attachment.

Overall, the results presented here clearly indicate some simple yet useful “rules” for designing bioinert surfaces. Regardless of whether the constituent polymeric materials are themselves reportedly cell adhesive, once assembled into thin films using a layer-by-layer approach, it is possible to easily fine-tune the assembled multilayers to be either cytophilic or cytophobic by simply understanding how film structure impacts film hydration and swelling, which ultimately determines cell interactions. A design paradigm is then as follows: adjusting processing conditions of pH and/or ionic strength easily allows one to systematically control, with nanoscale precision, the molecular architecture and ionic crosslinking of a multilayer system; this enables one to direct the multilayer's degree of hydration under physiological conditions, which then facilitates one to powerfully turn “on” or “off” cell adhesion. We thus revealed that it is not necessarily the specific polymers or functional groups used that determine cell response, as previously believed, but rather how those polymers are assembled into controlled molecular conformations. With weak polyelectrolytes, pH adjustments alone can effectively determine cell responses. Using a similar design scheme, it should be possible to identify many other electrostatically-assembled or hydrogen-bonded multilayer combinations, based on synthetic and/or biopolymers, to which cell adhesion may be switched “on” or “off.” For example, we have identified several highly hydrated, completely hydrogen-bonded multilayers, assembled from polyacrylamide (PAAm) and either PAA or PMA, which are also cell resistant. Yang, S. Y.; Mendelsohn, J. D.; Rubner, M. F., to be submitted. In a future paper, we will show that cell resistance can be achieved with these materials with only a single bilayer coating (PAH/PAA cell resistant films usually require at least 7 bilayers) and the films are stable in culture media for at least a month. The PAH/PAA bilayers also exhibit excellent stability in media for at least seven days.

Besides offering nanoscale control over the chemical, physical, and now even the biological properties of polymeric thin films, the layer-by-layer strategy has additional advantages for fabricating bio-interfaces. Due to their abundance of many unpaired functional groups (i.e., free amines and free acids in PAH/SPS 10.0/10.0 films and PAH/PAA 2.0/2.0 films, respectively), many cytophobic multilayers inherently possess a rich density of reactivity sites for further biochemical ligand modification. Hence, the same chemical groups that intrinsically render these materials highly swollen and bioinert also beneficially contain numerous sites for the subsequent tethering of RGD or other peptide sequences in order to selectively attract cells. Such cytophobic multilayers would therefore be useful for creating bioactive materials, embodying both an inert background and cell adhesive ligands. The facile ability to selectively pattern bioinert multilayers with physiologically relevant domains of biochemical ligands on the micron-scale is currently being investigated. Berg, M. C.; Yang, S. Y.; Mendelsohn, J. D.; Hammond, P. T.; Rubner, M. F., to be submitted. Using conventional patterning techniques, such as microcontact printing/stamping, inkjet printing, or other approaches, we have now demonstrated that it is possible to simply chemically “activate” only geometrically-precise regions for organized cell attachment and growth. Yang, S. Y.; Rubner, M. F. J. Amer. Chem. Soc. 2002, 124, 2100.

Furthermore, since the structural and chemical parameters of multilayers—the swellability, the surface wettability, and roughness, among others—may so easily be controlled, polyelectrolyte multilayer processing, in addition to creating useful bioinert materials, may help elucidate many still poorly-understood, fundamental aspects of cell-material interactions. With multilayer deposition, it is possible to systematically and easily control many processing parameters and determine their impact on cell adhesion and growth. Not only should this strategy for directing controlled biological-materials interactions be useful in tissue engineering and biomaterials in general, but other biotechnology processes, including nonfouling membranes and separation filters, bioreactors, biosensors, novel cell and protein arrays, and high-throughput combinatorial synthetic processes, could also greatly benefit. Moreover, multilayer deposition is aqueous-based and easily automated, and creates conformal coatings on flexible or rigid substrates of any size, shape, texture, or material. Thus, given its simplicity, nanoscale control, ability to incorporate materials with any desired function (e.g., enzymatic, antimicrobial, electroactive, specific ligand binding), potential for being made nano- and/or microporous (as for controlled release and membrane applications), and unprecedented potential in fine-tuning cell adhesion, polyelectrolyte multilayer deposition appears to be a powerful strategy for fabricating highly tailorable bio-interfaces. Mendelsohn, J. D.; Barrett, C. J.; Chan, V. V.; Pal, A. J.; Mayes, A. M.; Rubner, M. F. Langmuir 2000, 16, 5017; Hiller, J.; Mendelsohn, J. D.; Rubner, M. F. Nature Materials, 2002, 1, 59.

Definitions

For convenience, certain terms employed in the specification, examples, and appended claims are collected here.

The term “electrolyte” as used herein means any chemical compound that ionizes when dissolved.

The term “polyelectrolyte” as used herein means a polymeric electrolyte, such as polyacrylic acid.

The term “pH” as used herein means a measure of the acidity or alkalinity of a solution, equal to 7, for neutral solutions and increasing to 14 with increasing alkalinity and decreasing to 0 with increasing acidity.

The term “pH dependent” as used herein means a weak electrolyte or polyelectrolyte, such as polyacrylic acid, in which the charge density can be adjusted by adjusting the pH.

The term “pH independent” as used herein means a strong electrolyte or polyelectrolyte, such as polystyrene sulfonate, in which the ionization is complete or very nearly complete and does not change appreciably with pH.

The term “Kₐ” as used herein means the equilibrium constant describing the ionization of a weak acid.

The term “pKₐ” as used herein means a shorthand designation for an ionization constant and is defined as pKₐ=-log Kₐ. pKₐ values are useful when comparing the relative strength of acids.

The term “multilayer” as used herein means a structure comprised of two or more layers.

The term “polyacrylic acid” (PAA) as used herein means a polymer with repeating monomeric units of formula [—CH₂CH(COO⁻)—].

The term “polyallylamine hydrochloride” (PAH) as used herein means a polymer with repeating monomeric units of formula [—CH₂CH(CH₂NH₃⁺)—].

The term “polyacrylamide” (PAAm) as used herein means a polymer with repeating monomeric units of formula [—CH₂CH(CONH₂)—].

The term “polymethacrylic acid” (PMA) as used herein means a polymer with repeating monomeric units of formula [—CH₂C(CH₃)(COO⁻)—].

The terms “poly(styrene sulfonate)” (PSS) and “sulfonated polystyrene” (SPS) are used interchangeably herein, and refer to a polymer with repeating monomeric units of formula [—CH₂CH(C₆H₄(SO₃^{-))—].}

The term “polydiallyldimethylammonium chloride” (PDAC) as used herein means a polymer with repeating monomeric units of formula

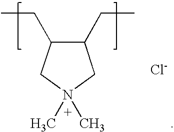

For purposes of this invention, the chemical elements are identified in accordance with the Periodic Table of the Elements, CAS version, Handbook of Chemistry and Physics, 67th Ed., 1986-87, inside cover.

Polyelectrolyte Multilayers of the Invention

As part of a program aimed at the discovery of bio-inert and bio-compatible coatings, we have explored the use of polyelectrolyte multilayers as relatively bio-inert coatings. Generally, multilayer deposition is a versatile technique whereby ultrathin films may be assembled on a surface. However, the influence of pH during the deposition process has not been explored previously. Importantly, we have discovered that pH control during the deposition of polyelectrolytes to form polyelectrolyte multilayers can be exploited to control the biological properties of the resulting multilayers.

In one embodiment of the present invention, such ultrathin polyelectrolyte films may be deposited on a surface, under pH-controlled deposition conditions, via the repetitive, sequential adsorption from dilute aqueous solution of oppositely charged polyelectrolytes. In another embodiment, again under pH-controlled deposition conditions, such ultrathin films may be deposited on a surface via the repetitive, sequential adsorption from dilute aqueous solution of polymers, of which at least one polymer is a polyelectrolyte, comprising complementary hydrogen-bond donor functionality or hydrogen-bond acceptor functionality or both.

Essentially any synthetic or natural polyion, including but not limited to poly(ethylene imine), poly(diallyldimethylammonium chloride), chitosan, glycosaminoglycans, polylysine, poly(glutamic acid), poly(aspartic acid), alginate, RNA, DNA and enzymes, may be used to fabricate these highly interpenetrated thin films in a simple environmentally-sound, aqueous-based process that is easily automated and able to be upscaled for mass production. The resulting polyelectrolyte multilayers can coat reproducibly substrates of any size or shape with well defined properties of film thickness, composition, conformation, roughness, and wettability. We have expanded upon the utility of the polyelectrolyte multilayer fabrication process by introducing the use of weak (pH-dependent) polyelectrolytes, such as polyacrylic acid (PAA) and polyallylamine hydrochloride (PAH). Such multilayers are electrostatically constructed via the carboxylate group (COO⁻) of PAA and the ammonium group (NH₃⁺) of PAH; by using these weak polyelectrolytes, we are able to fine-tune multilayer properties with nanoscale precision simply by adjusting the deposition pH of the polymer solutions. With this class of systems, one is afforded greater control over the physical state of the assembled polymers, such as their linear charge density, thickness, and conformation and the degree of interchain ionic bonding. Whereas strong polyelectrolytes typically deposit (in the absence of salt) as molecularly thin (˜5 Å) layers, weak polyelectrolytes can be deposited with a high percentage of segments comprising loops and tails by adsorbing under pH conditions of incomplete charge. In fact we have carried out experiments in our labs where layer thicknesses of >80 Å have been observed in weak PAA/PAH multilayers by depositing at a pH near the solution pKₐ of the polyelectrolytes.

In addition to being versatile and easy to process, PAA/PAH multilayers show a range of behavior when in contact with mammalian cells at physiological conditions. While surveying the response of the murine fibroblast NR6WT cell line to PAA/PAH multilayer systems assembled under different pH conditions, we discovered, quite surprisingly, that certain systems appear to be bio-inert. Thus, depending on the pH assembly conditions, PAA/PAH multilayers may either permit or, on the contrary, significantly prevent cell attachment. These cell experiments were performed in normal serum-containing media that includes many proteins and growth factors necessary for cell attachment, yet, even so, certain PAA/PAH multilayers are still effectively bioinert under these experiments.

Placing these results in context, the natural function of fibroblasts is to aid in wound healing and the synthesis of extracellular matrix, the insoluble scaffold upon which many cells are anchored in organisms. Of course, to function effectively, fibroblasts themselves must be able to attach to a physiological surface. Not surprisingly, fibroblasts are known to be highly adherent to both biological and synthetic surfaces. Notably, certain multilayers of the present invention resist adhesion by even these strongly adhesive cells, e.g., NR6WT fibroblasts.

Not surprisingly, the number of layers required to create the biological properties of a given multilayer film varies, i.e., it is a function of the particular combination of the polymers used to assemble the multilayer film. For example, a multilayer consisting of only two PAA/PAAm layers is sufficient to prevent cell attachment to the coated surface. However, for multilayers prepared according to the 2.0/2.0 PAA/PAH method, prevention of cell attachment requires a multilayer coating consisting of roughly at least twenty layers: a multilayer consisting of four layers is cell adhesive; a multilayer consisting of ten layers is somewhat adhesive; and a multilayer consisting of fifteen layers is marginally adhesive; whereas, a multilayer consisting of twenty layers is resistant to cells.

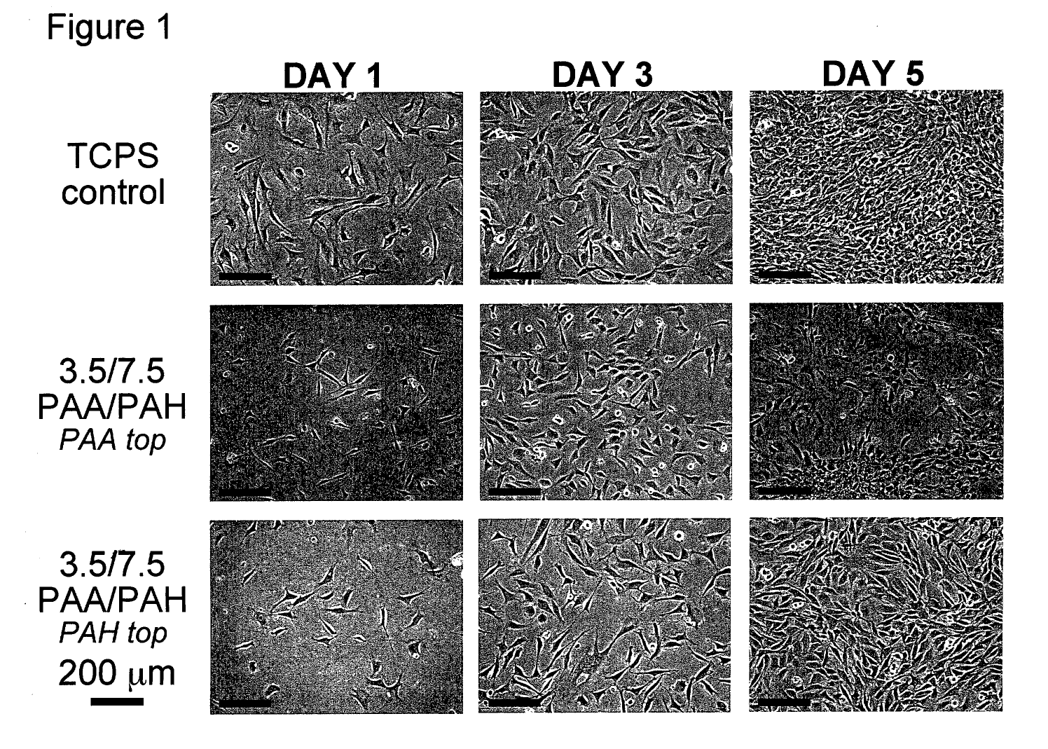

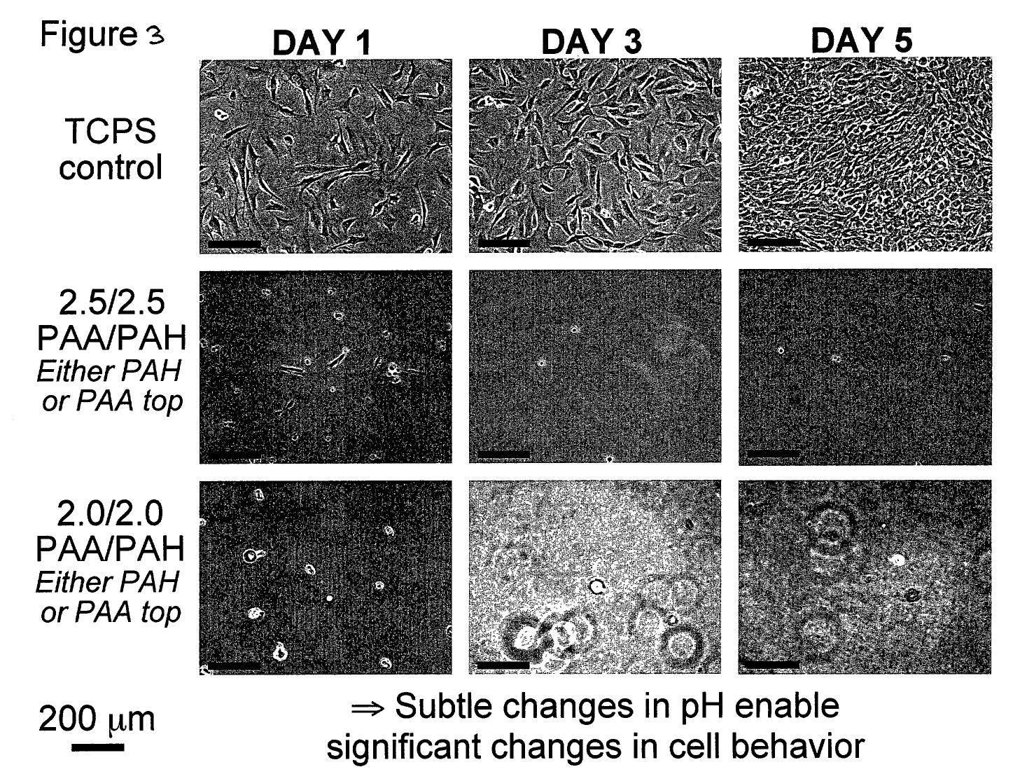

FIGS. 1-3 shows phase contrast microscopy pictures obtained over several days of the attachment and growth of NR6WT fibroblasts on a tissue culture polystyrene (TCPS) control (to which cells readily adhere) and on several different PAA/PAH multilayers assembled onto TCPS cell plates. Regardless of the identity of the outermost layer, PAA/PAH films deposited at pH values of 3.5/7.5 or 6.5/6.5, respectively, behave similar to TCPS controls in that the cells adhere readily to the surfaces and grow in number over time. The number of cells present on each different surface over time is presented in FIG. 4, where it can be seen that the cell population increases with time on TCPS and the 3.5/7.5 and 6.5/6.5 multilayer surfaces.

In stark contrast to TCPS controls and the other 3.5/7.5 and 6.5/6.5 PAA/PAH systems, fibroblasts seeded onto PAA/PAH multilayers assembled at pH 2.0/2.0 or 2.5/2.5, respectively, show essentially no attachment to those surfaces but rather simply float in the cell culture media. However, if those floating cells are transplanted to an uncoated TCPS control, the cells adhere and grow, suggesting that many of them remain alive while exposed to the non-adhesive 2.0/2.0 or 2.5/2.5 multilayer system; thus, it appears that the PAA/PAH 2.0/2.0 or 2.5/2.5 multilayers are both beneficially non-toxic and cell-resistant. Furthermore, we have identified other multilayer systems that are resistant to cell attachment. For example, hydrogen-bonded multilayers composed of polyacrylamide (PAAm) with either PAA or polymethacrylic acid (PMA) also demonstrate superior cell resistance. Therefore, by simply changing the deposition pHs of the constituent polyelectrolytes, we may obtain different thin film surfaces that not only exhibit a range of thickness, roughness, architectures, and wettability, but also cell-adhesive or bio-inert features. This invention demonstrates that pH-controlled polyelectrolyte multilayer deposition may be used to fabricate various bio-interfaces to control (i.e., permit or prevent) cell adhesion.

We note that PAH is quite cell-adhesive, as are carboxylic acid groups (COOH) generally, the chemical functionality found in PAA. These findings were obtained using self-assembled monolayers (SAMs), a common way to manipulate surface properties. Polyelectrolyte multilayers provide a much richer and versatile approach to processing polyions and, as demonstrated here, can be used to create cell-resistant surfaces from starting materials that are often found to be cell-adhesive.

We have also explored several other polyelectrolyte multilayer assemblies to assess their interactions with living cells. Table 1 depicts selected polymers used in the polyelectrolyte multilayers of the present invention. Numerous other polymers may be used in the polyelectrolyte multilayers of the present invention, including but not limited to poly(ethylene oxide), poly(vinyl alcohol), poly(ethylene imine), poly(diallyldimethylammonium chloride), chitosan, glycosaminoglycans, polylysine, poly(glutamic acid), poly(aspartic acid), alginate, RNA, DNA and enzymes.

TABLE 1
Selected polymers used in the multilayer
depositions of the present invention.

| | | | Charge/pH |
|---|---|---|---|
| | Polymer | | dependent or |
| Polymer Name | Abbreviation | Polymer Structure | independent |
| Polyacrylic acid | PAA | 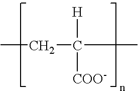 | Anionic/ pH dependent |
| Polyallylamine hydrochloride | PAH | 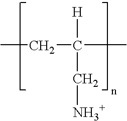 | Cationic/ pH dependent |
| Polyacrylamide | PAAm | 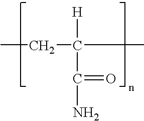 | Neutral |
| Polymethacrylic acid | PMA | 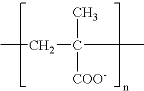 | Anionic/ pH dependent |
| Polystyrene sulfonate | SPS | 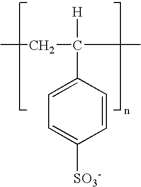 | Anionic/ pH dependent |
| Polydiallyl- dimethyl- ammonium chloride | PDAC | 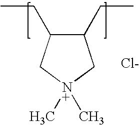 | Cationic/ pH independent |

We fabricated multilayers composed of PAH as the polycation that alternated with, instead of PAA, either the weak polyanion PMA, which like PAA has a ionizable carboxylic acid group or a strong (i.e., always fully charged) polyanion, poly(styrene sulfonate) (SPS), which has the charged sulfonate group, SO₃⁻. FIGS. 5-9 present cell morphology pictures over several days obtained on various PMA/PAH and SPS/PAH multilayer systems, respectively. Similar to the PAA/PAH combinations, multilayer thin films of PMA/PAH showed good cell adhesion at higher pH values, such as 4.5/4.5 and 6.5/6.5 PMA/PAH. However, PMA/PAH films assembled at lower deposition conditions of pH 2.5/2.5 demonstrated noticeable albeit not perfect cell resistance, as indicated by the rounded morphology of floating, non-adherent cells. Analogous to PAA/PAH and PMA/PAH systems, SPS/PAH thin films were similarly highly cell-adhesive at 6.5/6.5 but were additionally adhesive at values of 2.0/2.0. Thus, the entirely weak, non-fully charged polyelectrolyte multilayers of PAA/PAH and PMA/PAH were bio-inert at 2.0/2.0 and 2.5/2.5, respectively, whereas the fully charged SPS/PAH system was not at all bio-inert at 2.0/2.0; again, these results confirm how simple adjustments in the deposition pH's or the constituent polyions assembling the multilayers may lead to powerful differences in cell response.

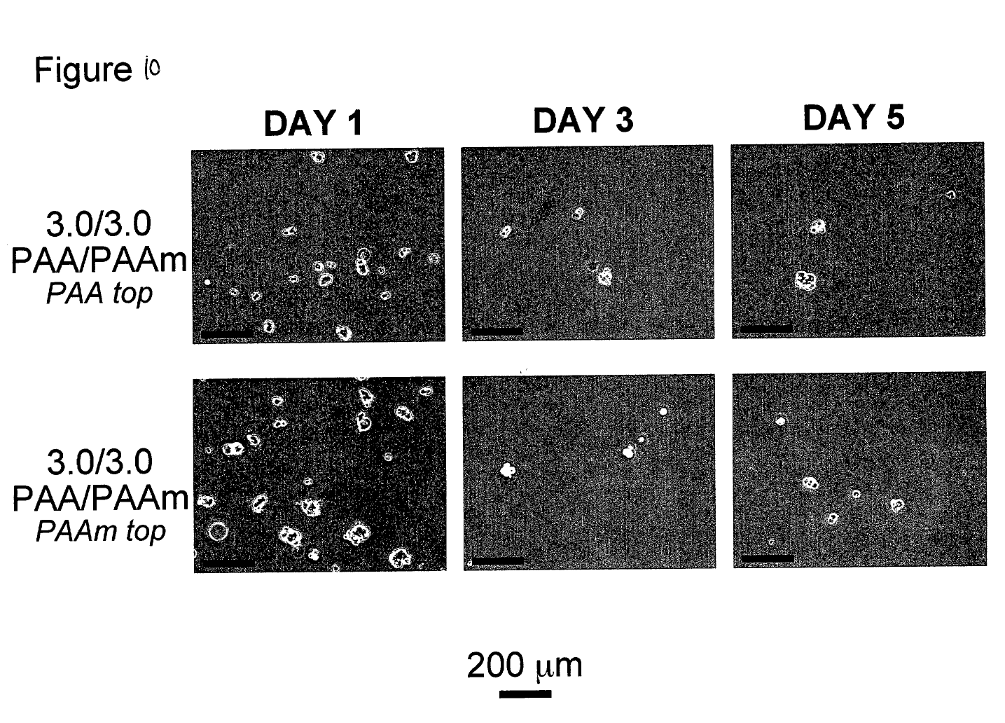

Further work has been performed to confirm the superior cell resistance of multilayers consisting of polyacrylamide (PAAm) and PAA. FIG. 10 shows cell pictures over several days of PAA/PAAm multilayers fabricated at 3.0/3.0, followed by heating as described below, where it is seen that cells exhibit only rounded, floating, non-adhesive morphologies. Only low pH combinations of PAA/PAAm have been tested, since PAA/PAAm films cannot be assembled at high pH conditions. This hydrogen bond-driven multilayer assembly occurs only when the majority of the carboxylic acid groups of PAA are non-ionized. Unlike any other polymers in this research, PAAm is a non-ionizable water-soluble polymer, which means it does not have charges even with a change in the pH of the solution. Therefore, the pH control of the layer-by-layer process would affect the charges only on PAA. When its carboxylic acid groups (COOH, non-ionized form) become carboxylate groups (COO⁻, charged form) at high pH, PAA is no longer a hydrogen bond donor, thus preventing the hydrogen bond formation between PAA and PAAm. Therefore, it is necessary to keep the pH of the assembling solutions low, because the COOH groups of PAA in the multilayer transform to COO⁻ whenever the assembled film was placed in high pH environment, and then the film would dissolve. Since the cell studies involve a high pH condition (pH 7.4 with a physiologically representative phosphate buffer solution), we needed to stabilize the PAA/PAAm multilayer with a simple heat-treatment to prevent the film from dissolving. For example, heating the film at 95° C. overnight (time and temperature can be varied) generates cyclic anhydride formation of the carboxylic acid groups, which gives enough stability of the film toward high pH. Therefore, the hydrogen-bonded multilayer remains stable on the TCPS substrate over the period of the study, as confirmed by FT-IR spectroscopy.

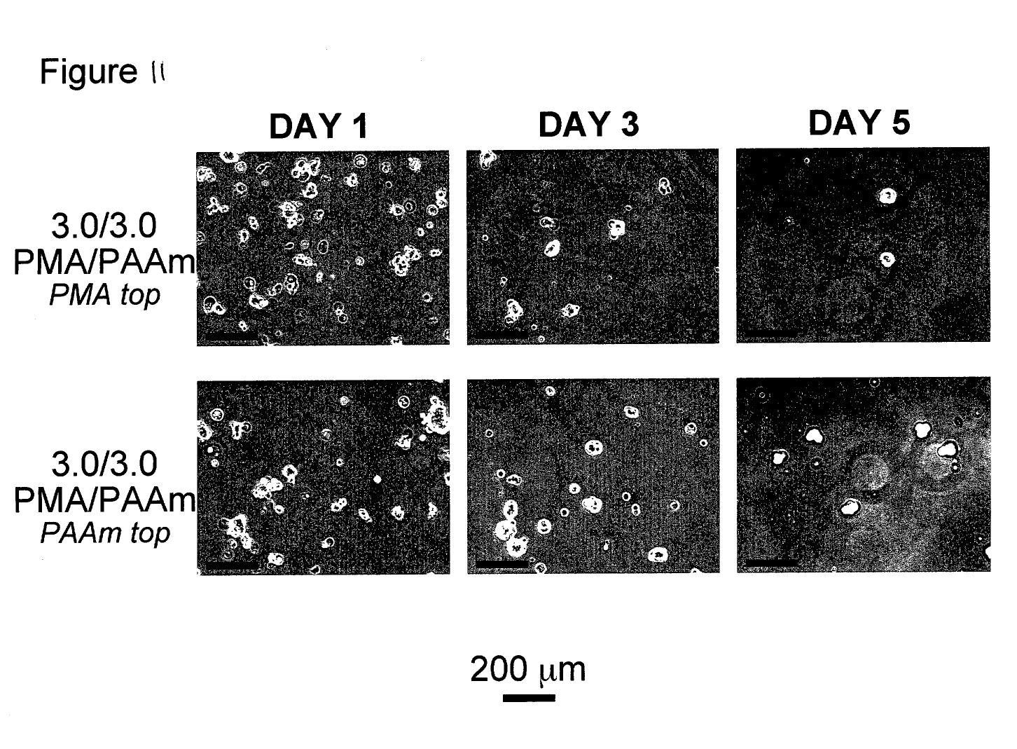

Multilayer films were also constructed from PMA and PAAm and, as demonstrated in FIG. 11, were similarly completely non-adherent. It should be noted this multilayer-based processing is a very important method of making thin films with PAAm. In spite of an intensive study of PAAm, we are the first to demonstrate an effective way to build insoluble thin films of PAAm without the need to resort to cross-linking reactions or grafting reactions or both during assembly of the multilayer. In addition, we achieved perfect cell-resistant surfaces from these PAAm and weak polyelectrolytes (PAA or PMA) combinations; such strongly cell-resistant surfaces have not been reported with PAAm gels.

Notably, the extent to which a polyelectrolyte multilayer based on hydrogen-bonding interactions prevents cell adhesion to a coated surface is not a function of the thickness of the multilayer. For example, multilayers consisting of 25 layers (about 180 nm thick) and multilayers consisting of 3 layers (about 2 nm thick) were equally effective at preventing cell adhesion in our experiments.

Architecture of Polyelectrolyte Multilayers.

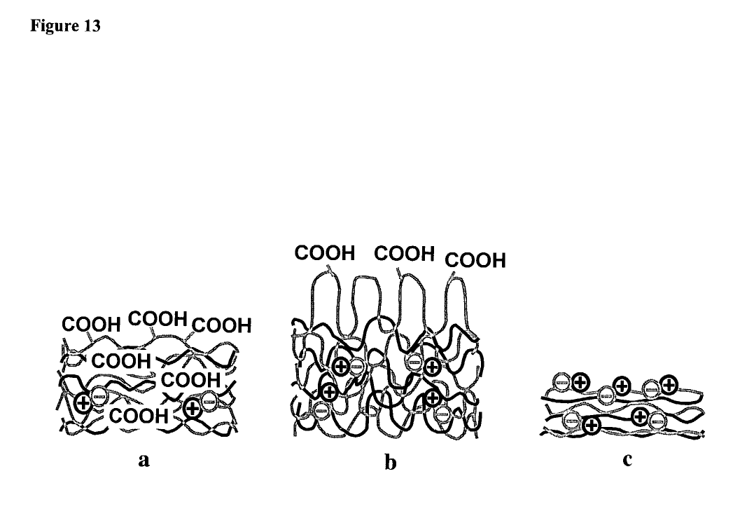

As described above, using weak polyions, such as PAH and PAA, enables the creation of a wide variety of multilayer structures simply by adjusting the pH-sensitive linear charge density of the assembling polymers. PAA (pKₐ˜5) and PAH (pKₐ˜9) contain ionizable carboxylic acids and amines, respectively. Thus, depending on the deposition pH conditions, the degree of ionization of these weak polyelectrolytes (i.e., the number of COO⁻ vs. COOH groups for PAA and the relative number of NH₃⁺ vs. NH₂ groups for PAH) as well as the number of ionic bonds (COO⁻—NH₃⁺) used to assemble the multilayers may be tuned as desired. As seen in Table 2 and FIG. 13, when PAH and PAA are each deposited from solutions at pH 6.5 (hereafter denoted as 6.5/6.5 PAH/PAA), both polymers are essentially fully-charged molecules and consequently form thin, flat layers due to a high ionic crosslink density. These 6.5/6.5 PAH/PAA films are comprised of an approximately equal blending of each polymer, and, regardless of the outermost layer, the films exhibit homogeneous, well-mixed surfaces.

When PAH and PAA are deposited at pH 7.5 and at pH 3.5, respectively (7.5/3.5 PAH/PAA), both the partially-ionized PAA and PAH molecules adsorb in loop-rich conformations, forming thick layers with a high degree of internal charge pairing. In this case, the multilayers do not possess well-blended surfaces, meaning that the chemical groups of the last deposited polymer dominate the surfaces. Of note, when PAA is the outermost layer, the film surface is rich in free, unpaired acids (COOH groups).

Multilayers assembled at pH 2.0 for each polyion (2.0/2.0 PAH/PAA) are enriched by PAA chains both within and on the surface of the film, irrespective of the outermost layer. These loopy 2.0/2.0 PAH/PAA multilayers overall exhibit little ionic crosslinking, since most of the PAA groups exist in their uncharged, protonated COOH state. The absorbance of the cationic dye methylene blue, which has previously been reported to bind to free, unpaired carboxylic acids (COOH), has confirmed a substantial amount of free acids both inside and on the surface of 2.0/2.0 PAH/PAA films. Shiratori, S. S.; Rubner, M. F. Macromolecules 2000, 33, 4213; Yoo, D.; Shiratori, S. S.; Rubner, M. F. Macromolecules 1998, 31, 4309. Details concerning the full characterization of these multilayers and what determines layer thickness etc., can be found in our previous papers. Shiratori, S. S.; Rubner, M. F. Macromolecules 2000, 33, 4213; Yoo, D.; Shiratori, S. S.; Rubner, M. F. Macromolecules 1998, 31, 4309; Choi, J.; Rubner, M. F. J. Macromol. Sci.—Pure Appl. Chem. 2001, A38, 1191. For the all of following cell studies, a sufficient number of layers was deposited to insure uniform coverage and to eliminate substrate effects. Hence, for multilayers systems with a very low average layer thickness (i.e., PAH/PAA 6.5/6.5), greater than 45 layers were typically deposited, whereas for multilayers fabricated from thicker layers, only about 20 layers were deposited (i.e., PAH/PAA7.5/3.5).

TABLE 2
Comparison of some of the important physical and chemical properties of
representative PAH/PAA multilayers.

| | 2.0/2.0 | 7.5/3.5 | 6.5/6.5 |
|---|---|---|---|
| | PAH/PAA^{a} | PAH/PAA^{a} | PAH/PAA^{b} |
| Average Layer thickness (Å) | ˜25 | ˜50-80 | <5 |
| RMS roughness (Å) | ˜50 | ˜20-50 | <10 |
| Relative composition | ˜25:75 | ˜60:40 | ˜50:50 |
| (PAH:PAA segments) | ˜40 | >90 | >90 |
| % ionization of acids | ˜1.18; ˜1.29 | ˜0.04; ˜0.17 | ˜0; ˜0 |
| (of PAA) | | | |
| Methylene blue adsorbance | ˜28; <10 | ˜53; <10 | ˜35^{d}; <10^{d} |
| for PAH- and PAA-topped | | | |
| films^{c} | | | |
| Advancing/receding contact | <10; <10 | <10; <10 | ˜25^{d}; <10^{d} |
| angles with water for PAH- | | | |
| topped films (°)^{c} | | | |
| Advancing/receding contact | | | |
| angles with water for PAA- | | | |
| topped films (°)^{c} | | | |

^{a}Measurements were typically obtained on dried films of 20 or 21 layers in thickness (even layer numbers refer to PAA outermost layers; odd layer numbers refer to PAH outermost layers). Layer thicknesses obtained from multiple samples generally do not vary by more than 10%.
^{b}Measurements were typically obtained on dried films of 50 or 51 layers in thickness.
^{c}Measurements acquired on films assembled onto glass substrates.
^{d}Data obtained from ref. #28.

Mammalian Cell Response to PAH/PAA Multilayers.

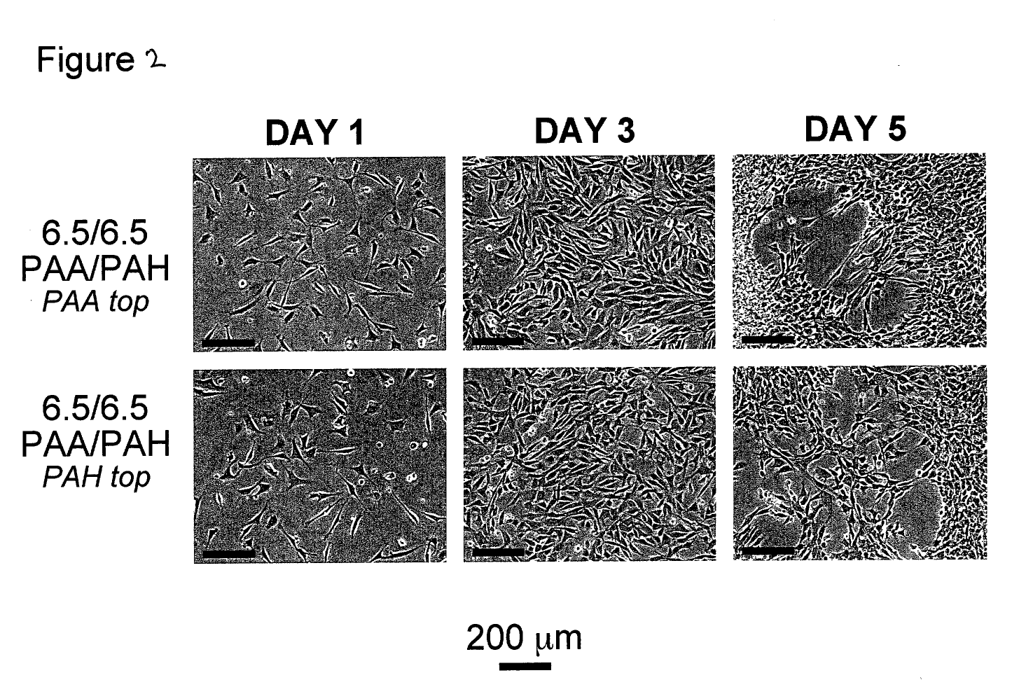

Upon seeding with murine NR6WT fibroblasts, the above PAH/PAA multilayers clearly showed drastic differences with regard to cell adhesion, as evident in FIG. 14. The fibroblasts exhibited substantial attachment, good spreading into their characteristic elongated morphologies, and noticeable proliferation onto both the 6.5/6.5 and 7.5/3.5 PAH/PAA multilayers, similar to that observed on a TCPS control. Trypan blue exclusion staining has also indicated excellent (>95%) cell viability on these cytophilic multilayers. As an anchorage-dependent cell line, capable of secreting their own adhesion molecules, NR6WT fibroblasts must be attached to a substrate for survival and are well known to be highly adherent to many biological and synthetic surfaces. Since all in vitro experiments were performed in serum-containing media, consisting of many essential proteins necessary for cell adhesion and growth, it was anticipated that the fibroblasts would readily attach and populate on any multilayer surface. Although cell attachment is observed on the TCPS control and the 6.5/6.5 and 7.5/3.5 PAH/PAA films, the 2.0/2.0 PAH/PAA multilayers, in stark contrast, completely resist the attachment of this highly adhesive cell line (FIG. 2a). Typically, ˜20 layers of the 2.0/2.0 PAH/PAA system were assembled on the TCPS substrates to ensure good uniform film coverage and high resistance to the attachment of the NR6WT fibroblasts. In fact, for most of the cell resistant multilayer systems described in this paper, it typically takes at least 15 layers to create a surface that resists cell attachment.

Significantly, the above findings of cytophilicity for the 6.5/6.5 and 7.5/3.5 systems and cytophobicity for the 2.0/2.0 PAH/PAA condition hold true regardless of the identity of the outermost layer of the film. In other words, 6.5/6.5 and 7.5/3.5 PAH/PAA multilayers are always cell adhesive, no matter whether PAH or PAA was the last layer adsorbed; similarly, 2.0/2.0 PAH/PAA films are always cell resistant, again irrespective of the last polyion deposited. These results are especially intriguing given the fact that, for instance, in the case of the 7.5/3.5 PAH/PAA system, PAH-topped films are overall positively-charged and contain some free amines, while PAA-topped multilayers are mainly negatively-charged and have some free acids in physiological buffer. Nevertheless, cells readily attach to either surface. Thus, regardless of its net surface charge and outermost layer identity, a single multilayer combination always remains either cell adhesive or cell resistant. In addition, wettability studies performed on multilayers exposed to nutrient media under identical conditions as those used in the cell culture experiments revealed fairly negligible differences in the contact angles with water between the 7.5/3.5 and the 2.0/2.0 PAH/PAA systems. In fact, both the cytophilic 7.5/3.5 and the cytophobic 2.0/2.0 PAH/PAA multilayers exhibited hydrophilic receding contact angles (indicative of molecular reorganization on the surface) of ˜15° and <10°, respectively, thereby suggesting that the issue of wettability alone cannot explain these drastic differences in the cell-multilayer interactions.

An important question arises as to whether any cells ever did initially adhere to and then subsequently detached from the cytophobic 2.0/2.0 multilayers. Such behavior would suggest that the multilayers are potentially cytotoxic. However, photographs obtained between 2 to 5 hours post-seeding revealed no cells ever attaching on the 2.0/2.0 PAH/PAA films. It should also be emphasized that the cells were never exposed to the rather harsh acidic conditions used during the assembly of the 2.0/2.0 system, which could lead to cell death. If the suspended cells from the 2.0/2.0 films were also transplanted to fresh TCPS surfaces, even after 2 days of floating, many cells readily attached and spread in a manner resembling normal, healthy cells, as seen in FIG. 14e. The transplanted cell population would increase as usual over several days as it would on any TCPS control; this observation again validates the concept that the bioinert 2.0/2.0 multilayers are not cytotoxic. Such materials are therefore suitable candidates for the bioinert backgrounds that eliminate undesirable, nonspecific cell adhesion.

By exploiting the flexibility of the layer-by-layer strategy and the results discussed above, we have also created heterostructures of cytophilic and cytophobic multilayers in the z-direction. When bioinert 2.0/2.0 PAH/PAA layers were assembled on top of an adhesive 6.5/6.5 PAH/PAA base, the attachment of the NR6WT fibroblasts damps out, and reaches complete cell resistance within about 10 layers (FIG. 15a-d). On the other hand, cytophilic 6.5/6.5 PAH/PAA layers, when deposited onto a cytophobic 2.0/2.0 base, mask the underlying bioinert multilayer in, once again, approximately 10 layers to consequently render the entire new composite film to be cell adhesive (FIG. 15e-h).

Protein Adsorption to PAH/PAA Multilayers.

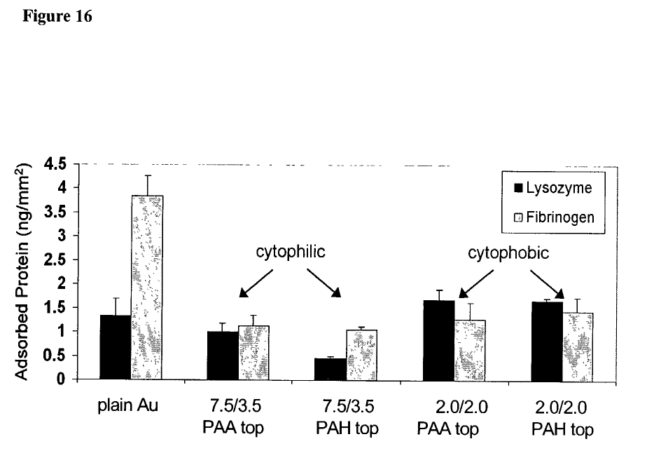

The issue of protein adhesiveness is often simultaneously investigated when performing in vitro cell studies with biomaterials. Although the 7.5/3.5 and 2.0/2.0 PAH/PAA combinations contrasted greatly in their ability to adhere fibroblasts, complementary protein adsorption studies, acquired using the technique of surface plasmon resonance (SPR), revealed that both systems attracted two model proteins, lysozyme and fibrinogen (FIG. 16). Green, R. J.; Frazier, R. A.; Shakesheff. K. M.; Davies, M. C.; Roberts, C. J.; Tendler, S. J. B.; Williams, P. M. Biomaterials 2000, 21, 1823. Relative to an uncoated gold control surface, both the 7.5/3.5 and the 2.0/2.0 PAH/PAA combinations significantly resisted (about a ⅔ reduction) the adsorption of the large, hydrophobic, predominantly anionic, cell adhesive protein fibrinogen. All multilayers also adsorbed the highly cationic lysozyme, regardless of their net surface charge. More specifically, with regards to the 7.5/3.5 system, about twice as much of the positively-charged lysozyme attached to films ending with an oppositely-charged PAA surface than to similarly-charged PAH-terminating films. For the 2.0/2.0 PAH/PAA case, when either polymer was the outermost layer, the films attracted lysozyme in substantially higher amounts than the 7.5/3.5 samples. Consistent with the fact that the surfaces of both PAH- and PAA-topped 2.0/2.0 multilayers are rich in ionized carboxylic acids (under buffered conditions), these films also exhibited a slight preference for the adsorption of the cationic lysozyme over the anionic fibrinogen. The fact that both the cytophilic 7.5/3.5 and the cytophobic 2.0/2.0 PAH/PAA multilayers could each readily adsorb proteins, along with the observation that the 2.0/2.0 films attracted more of each protein than the 7.5/3.5 system, indicates that differences in protein adhesiveness also cannot account for the significant differences in these cell-multilayer interactions.

Cell Response to PAH/PMA and PAH/SPS Multilayers

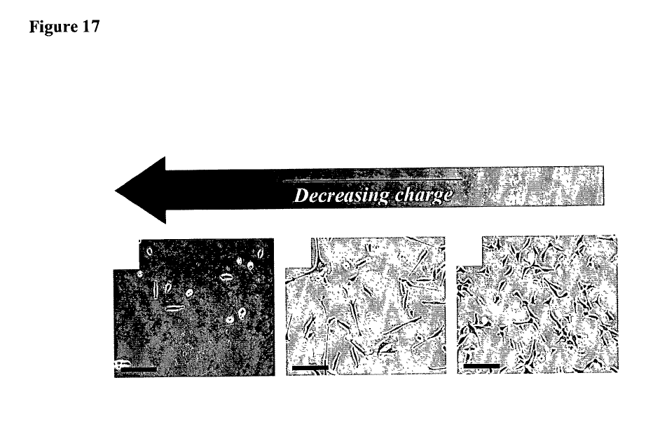

As stated previously, surface charge, wettability, and protein adhesion alone could not distinguish the cytophobic 2.0/2.0 PAH/PAA multilayers from the cytophilic 7.5/3.5 PAH/PAA system. To determine if the observations above were limited to films created specifically from PAA and PAH molecules, we assembled multilayers of PAH with the weak polyanion PMA, instead of PAA. Except for an additional hydrophobic methyl group in each repeat unit, PMA has ionizable carboxylic acid groups similar to PAA. As evident in FIG. 17, substituting PMA for PAA to fabricate PAH/PMA multilayers yielded analogous cell responses to PAH/PAA films, as previously demonstrated in FIG. 14. At pH 6.5/6.5 conditions, PAH/PMA films exhibited extensive cell adhesion yet showed substantially reduced cell attachment at 2.5/2.5 conditions. The 2.5/2.5 PAH/PMA system resembles the 2.0/2.0 PAH/PAA combination by having a high degree of free, unpaired carboxylic acids and thus little ionic crosslinking. 6.5/6.5 PAH/PMA films, having both polymers stitched in essentially fully charged, ultrathin conformations, exhibit dense ionic crosslinking and are therefore structurally analogous to the 6.5/6.5 PAH/PAA condition.

All of these results suggest that the structure and molecular organization of the multilayers, rather than any other aspect, is the key parameter in determining their interaction with NR6WT cells. More specifically, the findings with PAH/PAA and PAH/PMA indicate that lightly ionically crosslinked film structures promote cell resistance, while highly ionically crosslinked architectures allow cell attachment. To further test this hypothesis that structure and molecular arrangement alone dictates the resulting cell response, we assembled multilayers of PAH with the strong, pH-independent polyanion SPS instead of the pH-sensitive PAA or PMA. By understanding how the assembly conditions of PAH/PAA and PAH/PMA multilayers yielded cytophilic or cytophobic materials, it was possible to also design analogous structures using PAH and SPS and then confirm whether or not the PAH/SPS film architecture controls its cell response in a similar manner.

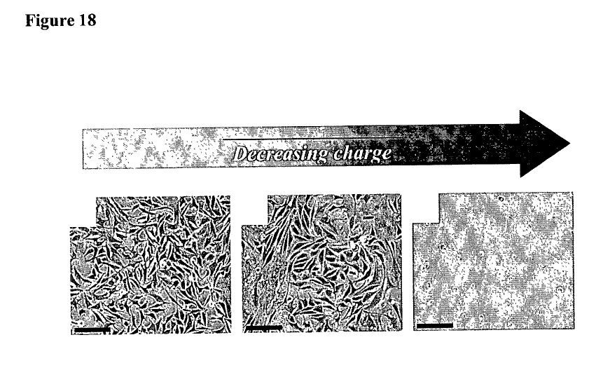

Unlike the PAH/PAA and PAH/PMA systems, the PAH/SPS combination produces fully charged, ultrathin (<5 Å/layer), highly ionically crosslinked multilayers under both pH 6.5/6.5 and 2.0/2.0 deposition conditions, since PAH and SPS are each essentially fully charged. By analogy, it would be expected that PAH/SPS films assembled at either 6.5/6.5 or 2.0/2.0 conditions would behave similarly in terms of their cell interactions to the fully ionized, tightly stitched PAH/PAA and PAH/PMA 6.5/6.5 cases. FIG. 18 validates this prediction, where it is seen that PAH/SPS films easily attracted cells at both pH 6.5/6.5 and at 2.0/2.0 conditions. Of course, more loop-rich, less ionically crosslinked architectures could be fabricated when the degree of ionization of PAH is reduced. With a pKₐ˜9, PAH is only slightly ionized at basic pH's, so consequently, a 10.0/10.0 PAH/SPS multilayer, for instance, adopts a thicker, more loopy conformation (>20 Å/layer) compared to ultrathin layers at fully-ionized pH conditions, such as at 6.5/6.5. The absorbance of rose bengal, an anionic dye which binds to free ammonium groups of PAH was considerably higher on PAH/SPS films prepared at the basic 10.0/10.0 condition, compared to films assembled at the neutral 6.5/6.5 condition. Thus, 10.0/10.0 PAH/SPS films possess a weakly ionically crosslinked structure with many unbound functional groups in a manner analogous to the lightly ionically stitched 2.0/2.0 PAH/PAA films, which contain many unpaired carboxylic acid groups. Similar to their 2.0/2.0 PAH/PAA counterparts, these 10.0/10.0 PAH/SPS multilayers exhibit substantial cytophobicity.

Cell Response to PDAC/SPS Multilayers

The above results with the various PAH/-PAA, -PMA, and -SPS systems suggest a general trend in the cell response to polyelectrolyte multilayers—densely ionically crosslinked films allow cell attachment, whereas loosely ionically stitched film architectures prevent all noticeable adhesion of the NR6WT fibroblasts. Moreover, these findings reveal that it is facile to actually fine-tune a polyelectrolyte multilayer—even if made from the same two constituent polyions to be either cytophilic or cytophobic, solely via simple adjustments in the molecular assembly conditions. Although the above examples all use pH to control the multilayer architecture, we hypothesized that another important multilayer deposition parameter, namely the ionic strength, could similarly be used to produce films that also showed cell responses dependent on the film structure.

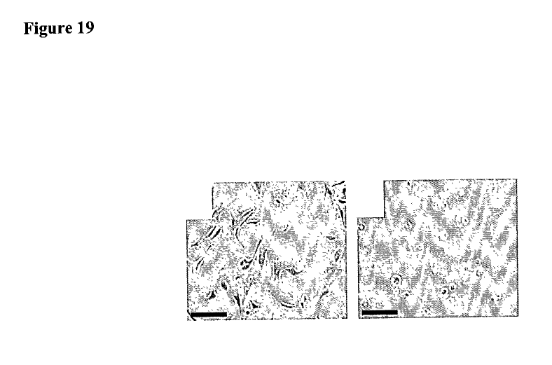

The addition of salt to the polymeric deposition solutions is often used with strong, pH-independent polyelectrolytes. Steitz, R.; Jaeger, W.; v. Klitzing, R. Langmuir 2001, 17, 4471. Much as pH is used to control the charge density along the assembling polyions, ionic strength may be used to shield charges and create thicker, more loop-rich, less cooperatively-stitched films from strong polyelectrolytes. Thus, we constructed films of two fully-charged polyelectrolytes, SPS and PDAC, with and without extraneous salt. As expected, PDAC/SPS films fabricated without salt are ultrathin (˜5 Å/layer), at all pH values due to the highly cooperative stitching of opposite charges. Furthermore, similar to the thin, fully-charged PAH/-PAA, -PMA, and -SPS systems (e.g., at pH 6.5/6.5 conditions for any of these systems), PDAC/SPS multilayers adsorbed at pH 6.5/6.5 without salt are also cytophilic, as revealed in FIG. 19. However, when 0.25 M NaCl was added to both the PDAC and SPS solutions, the partial screening of charges by the salt ions yielded much thicker, loop-rich films (˜25 Å/layer), resembling multilayers formed from weak polyelectrolytes assembled under pH conditions with an incomplete degree of ionization of one or both polymer(s). Relative to their fully charged, salt-free counterparts, these salt-assembled PDAC/SPS films possess a much less dense ionic crosslinking character, and, as expected for such architectures, these multilayers are cytophobic.

In-situ Swelling of Multilayers.

It is evident from the above results that the molecular organization of the multilayers is the critical variable in ultimately determining their cell interactions. In the case of the weak polyelectrolytes, all of the cytophobic conditions possess at least one constituent polymer with a low charge density as assembled and thus exhibit a lightly ionically crosslinked architecture. Similarly, for the strong polyion case, typified by the PDAC/SPS system, the salt-assembled films exhibited some charge shielding. Hence, we hypothesized that a multilayer's ionic architecture was related to its ability to swell under buffered conditions. Specifically, we assumed that the weakly crosslinked assemblies would substantially swell and hydrate in buffered physiological fluid conditions, thereby enabling cell resistance. To prove this hypothesis, we performed in-situ swelling experiments under PBS using fluid-cell AFM.

As depicted in FIG. 20, it is clear that all of the cell resistant thin films swelled in physiological buffer considerably more than their adhesive counterparts. More quantitatively, the cytophobic 2.0/2.0 PAH/PAA system swelled, on average, by almost 400% its original thickness. Thus, a hydrated, buffer-exposed 2.0/2.0 film is approximately 25% polymer and 75% water (buffer). In contrast, the cell adhesive 7.5/3.5 and 6.5/6.5 PAH/PAA multilayers swelled by only ˜130% and ˜115% their original heights in buffered conditions, respectively. Similar results were observed with the PAH/SPS assemblies—the cytophilic 2.0/2.0 and 6.5/6.5 multilayers swelled only ˜120% and ˜105%, respectively, compared with the cytophobic PAH/SPS 10.0/10.0 system that swelled ˜250%. The salt-assembled PDAC/SPS combination also exhibited a mean swelling of ˜315%, whereas the ultrathin, fully-ionized, salt-free case swelled by only ˜107%. Therefore, these findings suggest that having molecular conformations, which enable significant swelling in buffer, is necessary for a particular multilayer to exhibit cell resistance. Furthermore, returning to the data presented in FIG. 15, when 6.5/6.5 PAH/PAA layers were assembled onto an initially highly swollen 2.0/2.0 PAH/PAA base, the swelling of the overall heterostructure film damps out; when 10 layers of 6.5/6.5 PAH/PAA were deposited onto the 2.0/2.0 layers, the total film swelling was reduced to only ˜115%, consequently enabling cell attachment. These findings also further validate the concept that the swelling and hydration behavior of the entire film, rather than its surface and the identity of the last deposited layer, is responsible for a multilayer's interaction with living cells.

### Exemplification

The invention now being generally described, it will be more readily understood by reference to the following examples, which are included merely for purposes of illustration of certain aspects and embodiments of the present invention, and are not intended to limit the invention.

### EXAMPLE 1

Materials

Poly(acrylic acid) (PAA) (M_{W}˜90,000, 25% aqueous solution), poly(methacrylic acid) (PMA) (M_{W}˜100,000), and polyacrylamide (PAAm) (M_{W}˜800,000, 10% aqueous solution or 5,000,000, 1% aqueous solution) were obtained from Polysciences. Poly(allylamine hydrochloride) (PAH) (M_{W}˜70,000), sulfonated poly(styrene), sodium salt, (SPS), (M_{W}˜70,000), poly(diallyldimethylammonium chloride) (PDAC) (M_{W}˜100,000- 200,000) as a 20 wt. % solution, the methylene blue dye, and the rose bengal dye were purchased from Aldrich Chemical. The polymers were used without any further purification. Lysozyme (from chicken egg white, E.C. 3.2.1.17) and fibrinogen (fraction I, type I-S from bovine plasma, E.C. 232-598-6) were obtained from Sigma and prepared as 1 g/L and 0.2 g/L solutions, respectively, in Dulbecco's phosphate buffered saline (PBS) (pH˜7.4, with calcium and magnesium).

All polymer solutions were prepared as 10⁻² M solutions (based on the repeat unit molecular weight) using deionized, ultrapure 18 MΩ-cm Millipore water without the addition of any salt. The pH of the solutions was adjusted by adding HCl or NaOH. For the deposition of multilayers with PAAm, only dilute HCl (0.01 M) or NaOH (0.01 M) aqueous solutions without any salt was used to adjust the pH. The pH was measured using Orion Model 230A pH meter. Standard buffer solutions (pH 2.0, 3.0, 4.0, 7.0 and 10.0) for the pH calibration were purchased from VWR Scientific.

Multilayer systems assembled for surveying their interaction with living mammalian cells included: 1) PAA at pH 3.5, PAH at pH 7.5 (20 and 21 layers); 2) PAA at pH 6.5, PAH at pH 6.5 (50 and 51 layers); 3) PAA at pH 2.5, PAH at pH 2.5 (20 and 21 layers); 4) PAA at pH 2.0, PAH at pH 2.0 (20 and 21 layers); 5) PMA at pH 6.5, PAH at pH 6.5 (47 and 48 layers); 6) PMA at pH 4.5, PAH at pH 4.5 (25 and 26 layers); 7) PMA at pH 2.5, PAH at pH 2.5 (25 and 26 layers); 8) SPS at pH 6.5, PAH at pH 6.5 (40 and 41 layers); 9) SPS at pH 2.0, PAH at pH 2.0 (40 and 41 layers); 10) and PAA at pH 3.0, PAAm at pH 3.0 (3 to 26 layers); and 11) PMA at pH 3.0, PAAm at pH 3.0 (25 and 26 layers). In these exemplary multilayer systems, an even number of layers corresponds to a multilayer with PAA, SPS, or PMA as the outermost layer; while an odd number of layers corresponds to a multilayer with PAH or PAAm as the outermost layer.

Most of the samples in the hydrogen-bonded multilayers (the PAA/PAAm and PMA/PAAm systems) were prepared from pH 3.0 polymer solutions. The multilayers prepared from lower pH polymer solutions (for example, pH 2.5) did not show differences from the multilayers at pH 3.0. The higher pH polymer solutions (pH 3.5) yielded thinner multilayers than those assembled at pH 3.0 with the same number of layers. In addition, since the tissue culture polystyrene substrates (TCPSs) have a slight negative charge, all PAA/PAAm and PMA/PAAm films were primed with a single layer of PAH at pH 3.0, in order to facilitate the subsequent deposition of the multilayers. Prior to multilayer assembly, all polymer solutions were filtered through a 0.45 μm cellulose acetate membrane.

### EXAMPLE 2

Preparation of Polyelectrolyte Multilayer Thin Films

All polyelectrolyte multilayer thin films were deposited directly onto tissue culture polystyrene (TCPS) petri dishes and multiwell plates (Falcon), TCPS slides (Nalgene), polished <100> silicon wafers (Wafernet), glass slides (VWR Scientific), and ZnSe crystals (SpectraTech) at room temperature via an automatic dipping procedure using an HMS programmable slide stainer from Zeiss, Inc. The TCPS substrates were first immersed in the polycationic solution (e.g., PAH) for 15 minutes followed by rinsing in 3 successive baths of deionized neutral water (pH≈5.5-6.5) with light agitation, for 2, 1, and 1 minute(s), respectively. The substrates were then immersed into the oppositely charged polyanionic solution (e.g., PAA, PMA, or SPS) for 15 minutes and subjected to the same rinsing procedure. This process was repeated until the desired number of layers was assembled, after which the coated substrates were removed from the automatic dipping machines and blown dry with compressed, filtered air. TCPS substrates were additionally dried at ˜90° C. for ˜5 min. A layer in this paper refers to a single polyelectrolyte layer whereas a bilayer refers to the combination of a polycation and polyanion layer.

Crosslinking by Thermal Treatment

Hydrogen-bonded multilayers are sensitive to pH changes. In order to stabilize the multilayer films in the pH conditions required for the cell culture studies (pH 7.4 in a phosphate buffer solution), the films were thermally crosslinked overnight (usually more than 8 hours at this temperature, although the time and temperature can be varied) at 95° C. under vacuum (30 psi). Heating the film generated anhydride functional groups from the carboxylic acid groups in the multilayers, imparting high pH stability to the film. The hydrogen-bonded multilayers remained stable on the TCPS substrate over the period of the study, as confirmed by FT-IR spectroscopy; these studies were performed on ZnSe crystals coated with the hydrogen-bonded multilayers on a Nicolet FT-IR spectrometer operating with Omnic software.

### EXAMPLE 3

Film Thickness

The thickness and refractive index of the multilayer films deposited onto silicon were measured using a Gaertner ellipsometer, operating at 633 nm.

Film Roughness and Morphology

Atomic force microscopy (AFM, Digital Instruments Dimension 3000 Scanning Probe Microscope, Santa Barbara, Calif.) was used in tapping mode with Si cantilevers for surface morphology profiling and roughness measurements (dry state) of sample films built on silicon. Typically, square images of 1×1, 5×5, or 10×10 μm² images were obtained for samples using a scanning rate of ˜1-1.5 Hz, a setpoint ˜1-1.5 V, and a resolution of 512 samples/line.

UV-visible Spectroscopy

Samples assembled onto glass substrates were immersed in either the methylene blue solution (prepared as a 10⁻³ M solution in Millipore water, adjusted to pH˜7.0) or the rose bengal dye solution (10⁻³ M solution in Millipore water, adjusted to pH˜5.0) for 15 min followed by 3 successive deionized neutral water rinses with agitation for 2, 1, and 1 minute(s), respectively. UV-visible absorbance spectra were then obtained on dried films using an Oriel Intraspec II spectrometer with a grating spacing of 150 nm. Measurements include absorption from multilayers on both sides of the substrate.

FT-IR Spectroscopy

A Nicolet Fourier transform infrared (FT-IR) spectrophotometer was used to obtain absorbance spectra (in transmission mode) after depositing the polyelectrolyte multilayers onto ZnSe substrates. Absorbance values for the COO⁻ and COOH peaks of the PAA were estimated by examining the absorbance bands at ˜1550 cm⁻¹ and ˜1710 cm⁻¹, respectively, and assuming approximately equal extinction coefficients. Each peak height was also assumed to be the maximum of a Gaussian absorbance curve for its respective chemical species.

Wettability

Complimentary wettability studies, following a previously-described method, were performed on multilayer-coated TCPS slides preconditioned in either Dulbecco's phosphate buffered saline (PBS) with calcium and magnesium (pH˜7.4) or complete nutrient media (pH˜7.4, with 7.5% fetal bovine serum (FBS)) for a minimum of 7 days in a humid 37° C./5% CO₂ incubator. Choi, J.; Rubner, M. F. J. Macromol. Sci.—Pure Appl. Chem. 2001, A38, 1191. After being removed from the incubator, the samples were rinsed briefly with pure Millipore water and flushed dried with N₂ gas before wettability measurements were acquired. With an Advanced Surface Technology (AST) device and camera, advancing and receding contact angles with pure, deionized water were obtained using the standard sessile drop technique with drops ˜2 μL in size.

Swelling Experiments

The in-situ swelling of representative multilayer thin film samples assembled onto silicon substrates was obtained by using an AFM with a fluid cell in contact mode with Si₃N₄ cantilevers under fluid (PBS with calcium and magnesium (pH˜7.4)), similar to a previous report. Dubas, S. T.; Schlenoff, J. B. Langmuir 2001, 17, 7725. The dry, “in air” multilayer thickness values were determined by ellipsometry as indicated previously. AFM measurements were also used to obtain dry thickness values: both techniques gave values within 10% of each other. To obtain the swollen film thickness of a sample, first a scratch was made down to the bare silicon, followed by applying a drop of PBS over the scored area. The drop was allowed to equilibrate for a minimum of 2 hours in order for the buffer-exposed film to reach a stable swollen height, and then the drop area was scanned to find the swollen, “under fluid” thickness. Any swelling information could then easily be obtained by comparing the relative differences between the dry, ellipsometric-derived film thickness and the “under fluid” sample thickness. A minimum of two areas across the scored line on two different samples for each multilayer system was scanned.

Surface Plasmon Resonance (SPR)

Using a BIAcore™ 2000 SPR instrument (Biacore, Inc.), polyelectrolyte multilayers were assembled in-situ at 25° C. onto plain gold-coated glass sensor chips. PAH and PAA were prepared as 5×10⁻³ M and 1×10⁻³ M solutions in Millipore water for the 2.0/2.0 and 7.5/3.5 multilayers, respectively, and then pH adjusted. All polymer solutions were then filtered through a 0.2 μm Acrodisc® filter. Neutral Millipore water was used as the buffer in all multilayer assembly procedures and was flowed over a new gold chip for a minimum of 1 hour prior to film deposition. Beginning with PAH as the first layer, PAA and PAH were injected (volume=100 μL) one at a time with a flow rate of 20 μL/min over the gold surface. After injection, the flow cell was washed for 2 minutes with neutral water, before the introduction of the next polyelectrolyte. This process was repeated until 10 or 11 layers were assembled for the 7.5/3.5 system and 14 or 15 layers for the 2.0/2.0 PAH/PAA case. These number of layers were examined due to thickness limitations of the SPR technique.

After the appropriate number of layers had been adsorbed onto the gold chip, the buffer was changed from water to Dulbecco's PBS (with magnesium and calcium), which was flowed over the multilayer-coated gold sensor substrate for at least 1 hour at a flow rate of 20 μL/min. Then 100 μL of lysozyme and fibrinogen were injected with a flow rate of 10 μL/min over separate flow channels (i.e., there was no competition between the proteins in binding to the film). PBS was then used again to flow over multilayer and wash it of any excess or poorly bound protein. The magnitude of the adsorption of lysozyme and fibrinogen to each multilayer surface was then quantified graphically with the Biacore software, using the given relationship that an increase of 1000 response units (RU)=1 ng/mm² of adsorbed protein.

### EXAMPLE 4

Cell Culture Experiments

Unless stated otherwise, the cell culture reagents were purchased from Gibco/Invitrogen. Murine NR6WT fibroblasts, a cell line derived from mouse NIH 3T3 cells, were obtained from the laboratory of Prof. Linda Griffith at MIT. Standard sterile cell culture techniques were used for all cell experiments.

After TCPS substrates were coated with the desired multilayer system, e.g., with the appropriate number of layers (i.e., PMA, SPS, PAA, PAH, or PAAm as the outermost layer), the substrates were sterilized with 70% ethanol (VWR Scientific). The NR6WT fibroblasts were cultured in a humid 37° C./5% CO₂ incubator in pH˜7.4 growth media consisting of Modified Eagles alpha-Medium (alpha-MEM), supplemented with 7.5% fetal bovine serum (FBS), 1% nonessential amino acids (10 mM), 1% sodium pyruvate (100 mM), 1% L-glutamine (200 mM), 1% penicillin (Sigma), 1% streptomycin (Sigma), and 1% Geneticin (G418) antibiotic (350 μm/mg). For normal cell maintenance, cells were grown near confluence in Falcon T75 flasks, washed once with warm Dulbecco's phosphate buffered solution (PBS), detached with trypsin (1X) (Sigma), and passaged semiweekly.

For attachment and proliferation assays, the cells were resuspended in serum-containing media after the trypsinization, and then spun down in a centrifuge at ˜1000 rpm for ˜5 minutes. The cells were then resuspended in fresh media, mixed in a 1:1 ratio with 0.4% trypan blue and counted with a hemocytometer with trypan blue exclusion to determine cell viability prior to seeding. The NR6WT fibroblasts were seeded at ˜10 000 cells/cm² onto the sterilized multilayer-coated substrates on day 0, and their population was counted daily with a hemocytometer with trypan blue exclusion. A Nikon inverted phase contrast microscope with Openlab 3.0 software was used for all experiments to capture images of the cell density, morphology, spreading, etc. on the various multilayer surfaces over a minimum of 5 days. In the cell attachment and proliferation assays, the media was changed daily, except for cases where cells did not adhere to the multilayers, when media was instead changed at most every other day.

### Incorporation by Reference

All of the patents and publications cited herein are hereby incorporated by reference.

### Equivalents

Those skilled in the art will recognize, or be able to ascertain using no more than routine experimentation, many equivalents to the specific embodiments of the invention described herein. Such equivalents are intended to be encompassed by the following claims.

We claim:

1. A method of coating a surface, comprising sequentially depositing on a surface, under pH-controlled conditions, alternating layers of polymers to provide a coated surface, wherein a first polymer is selected from the group consisting of pH dependent cationic polyelectrolytes and neutral polymers, and a second polymer is selected from the group consisting of anionic polyelectrolytes, thereby preventing or permitting cell adhesion to said coated surface.

2. The method of claim 1, wherein cell adhesion to said coated surface is prevented.

3. The method of claim 1, wherein cell adhesion to said coated surface is permitted.

4. The method of claim 2, wherein said second polymer is a pH dependent anionic polyelectrolyte.

5. The method of claim 4, wherein said second polymer is polyacrylic acid (PAA).

6. The method of claim 4, wherein said second polymer is polymethacrylic acid (PMA).

7. The method of claim 2, wherein said first polymer is polyallylamine hydrochloride (PAH).

8. The method of claim 2, wherein said first polymer is polyacrylamide (PAAm).

9. The method of claim 3, wherein said second polymer is poly(styrene sulfonate) (SPS).

10. The method of claim 2 or 3, wherein said second polymer is a pH dependent anionic polyelectrolyte.

11. The method of claim 10, wherein said second polymer is PAA.

12. The method of claim 10, wherein said second polymer is PMA.

13. The method of claim 2 or 3, wherein said first polymer is PAH.

14. The method of claim 4, wherein said first polymer is PAH; and said second polymer is PAA.

15. The method of claim 4, wherein said first polymer is PAH; and said second polymer is PMA.

16. The method of claim 4, wherein said first polymer is PAAm; and said second polymer is PAA.

17. The method of claim 4, wherein said first polymer is PAAm; and said second polymer is PMA.

18. The method of claim 3, wherein said first polymer is PAH; and said second polymer is SPS.

19. The method of claim 10, wherein said first polymer is PAH; and said second polymer is PAA.

20. The method of claim 10, wherein said first polymer is PAH; and said second polymer is PMA.

21. The method of claim 2, wherein said first polymer is a pH dependent cationic polyelectrolyte deposited at a pH between about 2.0 and about 2.5; and said second polymer is deposited at a pH between about 2.0 and about 2.5.

22. The method of any of claims 4, 5, or 6, wherein said first polymer is a pH dependent cationic polyelectrolyte deposited at a pH between about 2.0 and about 2.5; and said second polymer is deposited at a pH between about 2.0 and about 2.5.

23. The method of claim 14 or 15, wherein the PAH is deposited at a pH between about 2.0 and about 2.5; and said PAA or PMA is deposited at a pH between about 2.0 and about 2.5.

24. The method of claim 14 or 15, wherein the PAH is deposited at a pH of about 2.5; and
said PAA or PMA is deposited at a pH of about 2.5.

25. The method of claim 3, wherein said first polymer is a pH dependent cationic polyelectrolyte deposited at a pH of about 7.5; and said second polymer is PAA deposited at a pH of about 3.5.

26. The method of claim 3, wherein said first polymer is a pH dependent cationic polyelectrolyte deposited at a pH of about 6.5; and said second polymer is PAA deposited at a pH of about 6.5.

27. The method of claim 3, wherein said first polymer is a pH dependent cationic polyelectrolyte deposited at a pH of about 4.5; and said second polymer is PMA deposited at a pH of about 4.5.

28. The method of claim 3, wherein said first polymer is a pH dependent cationic polyelectrolyte deposited at a pH of about 6.5; and said second polymer is PMA deposited at a pH of about 6.5.

29. The method of claim 3, wherein said first polymer is PAH deposited at a pH of about 7.5; and said second polymer is PAA deposited at a pH of about 3.5.

30. The method of claim 3, wherein said first polymer is PAH deposited at a pH of about 6.5; and said second polymer is PAA deposited at a pH of about 6.5.

31. The method of claim 3, wherein said first polymer is PAH deposited at a pH of about 4.5; and said second polymer is PMA deposited at a pH of about 4.5.

32. The method of claim 3, wherein said first polymer is PAH deposited at a pH of about 6.5; and said second polymer is PMA deposited at a pH of about 6.5.

33. The method of claim 16, wherein the PAAm is deposited at a pH between about 2.5 and about 3.5; and the PAA is deposited at a pH between about 2.5 and about 3.5.

34. The method of claim 17, wherein the PAAm is deposited at a pH between about 2.5 and about 3.5; and the PMA is deposited at a pH between about 2.5 and about 3.5.

35. The method of claim 16, wherein the PAAm is deposited at a pH of about 3.0; and the PAA is deposited at a pH of about 3.0.

36. The method of claim 17, wherein the PAAm is deposited at a pH of about 3.0; and the PMA is deposited at a pH of about 3.0.

37. The method of claim 16, 17, 33, 34, 35, or 36, further comprising heating the coated surface at about 95° C. for about 8-12 hours.

38. An article coated by the method of claim 1.

39. An article coated by the method of claim 2.

40. An article coated by the method of claim 3.

41. An article coated by the method of claim 14.

42. An article coated by the method of claim 15.

43. An article coated by the method of claim 16.

44. An article coated by the method of claim 17.

45. An article coated by the method of claim 18.

46. An article coated by the method of claim 19.

47. An article coated by the method of claim 20.

48. An article coated by the method of claim 37.

49. The article of claim 38, 39, 40, 41, 42, 43, 44, 45, 46, 47, or 48, wherein said article is selected from the group consisting of blood vessel stents, angioplasty balloons, vascular graft tubing, prosthetic blood vessels, vascular shunts, heart valves, artificial heart components, pacemakers, pacemaker electrodes, pacemaker leads, ventricular assist devices, contact lenses, intraocular lenses, sponges for tissue engineering, foams for tissue engineering, matrices for tissue engineering, scaffolds for tissue engineering, biomedical membranes, dialysis membranes, cell-encapsulating membranes, drug delivery reservoirs, drug delivery matrices, drug delivery pumps, catheters, tubing, cosmetic surgery prostheses, orthopedic prostheses, dental prostheses, wound dressings, sutures, soft tissue repair meshes, percutaneous devices, diagnostic biosensors, cellular arrays, cellular networks, microfluidic devices, and protein arrays.

50. A method of rendering a surface cytophilic, comprising the step of coating a surface with a polyelectrolyte multilayer film, which film swells to less than or equal to about 150% of its original thickness when exposed to an aqueous medium.

51. A method of rendering a surface cytophobic, comprising the step of coating a surface with a polyelectrolyte multilayer film, which film swells to greater than or equal to about 200% of its original thickness when exposed to an aqueous medium.

52. An article coated according to the method of claim 50.

53. An article coated according to the method of claim 51.

54. The article of claim 52 or 53, wherein said article is selected from the group consisting of blood vessel stents, angioplasty balloons, vascular graft tubing, prosthetic blood vessels, vascular shunts, heart valves, artificial heart components, pacemakers, pacemaker electrodes, pacemaker leads, ventricular assist devices, contact lenses, intraocular lenses, sponges for tissue engineering, foams for tissue engineering, matrices for tissue engineering, scaffolds for tissue engineering, biomedical membranes, dialysis membranes, cell-encapsulating membranes, drug delivery reservoirs, drug delivery matrices, drug delivery pumps, catheters, tubing, cosmetic surgery prostheses, orthopedic prostheses, dental prostheses, wound dressings, sutures, soft tissue repair meshes, percutaneous devices, diagnostic biosensors, cellular arrays, cellular networks, microfluidic devices, and protein arrays.
